(19) United States
(12) Patent Application Publication
(10) Pub. No.: US 2025/0117893 A1
(43) Pub. Date: Apr. 10, 2025

(54) Self Supervised Training of Machine-Learned Image Processing Models for Histopathology

(71) Applicant: Google LLC, Mountain View, CA (US)

(72) Inventors: David Steiner, Redwood City, CA (US); Ellery Alyosha Wulczyn, Oakland, CA (US); Po-Hsuan Chen, Mountain View, CA (US); Ronnachai Jaroensri, Stateline, NV (US); Supriya Vijay, San Jose, CA (US); Jeremy Lai, Newton, MA (US); Saloni Agarwal, Bellevue, WA (US); Yun Liu, Mountain View, CA (US); Faruk Ahmed, Mountain View, CA (US)

(21) Appl. No.: 18/908,549

(22) Filed: Oct. 7, 2024

Related U.S. Application Data
(60) Provisional application No. 63/588,483, filed on Oct. 6, 2023.

(51) Int. Cl. G06T 5/60; G06T 3/40; G06T 5/50

(52) U.S. Cl. CPC G06T 5/60; G06T 3/40; G06T 5/50; G06T 2207/20081

(57) ABSTRACT

An example computer-implemented method for self-supervised training of an image processing model for histopathology images is provided. The example method includes obtaining a reference histopathology image; generating an augmented histopathology image, wherein generating the augmented histopathology image comprises performing, for an input image, at least one of the following augmentations: applying a blur to the input image and injecting noise artifacts into the blurred input image; or cropping a plurality of portions from the input image, wherein the plurality of portions are determined based on a minimum overlap criterion that has been updated over one or more iterations; and training the image processing model based on a similarity of latent representations generated by the image processing model respectively for the reference histopathology image and the augmented histopathology image.

### PRIORITY

This application claims priority to U.S. Provisional Patent Application No. 63/588,483, which was filed Oct. 6, 2023, and which is hereby incorporated by reference herein in its entirety.

### FIELD

The present disclosure relates generally to machine learning processes and machine-learned devices and systems. More particularly, the present disclosure relates to self-supervised training of machine-learned image processing models.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide a first example method. In some implementations, the first example method can include obtaining a reference histopathology image. In some implementations, the first example method can include generating an augmented histopathology image, wherein generating the augmented histopathology image includes performing, for an input image, at least one of the following augmentations: applying a blur to the input image and injecting noise artifacts into the blurred input image; or cropping a plurality of portions from the input image, wherein the plurality of portions are determined based on a minimum overlap criterion that has been updated over one or more iterations. In some implementations, the first example method can include training the image processing model based on a similarity of latent representations generated by the image processing model respectively for the reference histopathology image and the augmented histopathology image.

Example aspects of the present disclosure provide a second example method. In some implementations, the second example method can include obtaining a reference histopathology image. In some implementations, the second example method can include generating an augmented histopathology image. In some implementations, the second example method can include training the image processing model using a hybrid loss function computed based on a similarity of latent representations generated by the image processing model respectively for the reference histopathology image and the augmented histopathology image. In the second example method, the hybrid loss function can include a first loss component including a contrastive loss computed using at least one of the latent representations and a negative latent representation generated by the image processing model for a negative training example. In the second example method, the hybrid loss function can include a second loss component computed using similarities determined between the latent representations and a plurality of learnable prototypes.

Example aspects of the present disclosure provide a third example method. In some implementations, the third example method can include obtaining an initial training dataset including a plurality of inputs. In some implementations, the third example method can include training the machine-learned embedding model using a training objective over the training dataset. In some implementations, the third example method can include clustering the initial training dataset using the trained machine-learned embedding model to generate a plurality of clusters of training examples. In some implementations, the third example method can include generating an updated training dataset by sampling training examples from the plurality of clusters of training examples, wherein the training examples are sampled based on a desired data distribution for the updated training dataset.

Example aspects of the present disclosure provide a fourth example method. In some implementations, the fourth example method can include tokenizing an input image into a plurality of tokens. In some implementations, the fourth example method can include constructing an input sequence that includes a plurality of input embeddings respectively for the plurality of tokens. In some implementations, the fourth example method can include processing the input sequence with the machine-learned sequence processing model to generate updated representations for the plurality of tokens. In some implementations, the fourth example method can include generating a partial aggregated representation over the updated representations for a subset of the plurality of tokens. In some implementations, the fourth example method can include determining a latent representation associated with the input image based on the partial aggregated representation.

Example aspects of the present disclosure provide a fourth example method. In some implementations, the fourth example method can include obtaining a reference histopathology image at a native magnification. In some implementations, the fourth example method can include generating, from the reference histopathology image, a plurality of image patches at a respectively plurality of emulated magnifications, wherein the plurality of image patches conform to an input dimension of the image processing model, wherein the plurality of emulated magnifications are obtained by at least one of: generating an emulated higher magnification by processing a portion of the reference histopathology image using an upsampling algorithm, wherein the emulated higher magnification corresponds to a higher than native magnification; or generating an emulated lower magnification by processing a portion of the reference histopathology image using a downsampling algorithm, wherein the emulated lower magnification corresponds to a lower than native magnification. In some implementations, the fourth example method can include training the image processing model using the plurality of image patches.

Example aspects of the present disclosure provide a machine-learned model trained according to any one of, or any combination of, the preceding example implementation(s) of the example method(s).

Example aspects of the present disclosure provide one or more non-transitory computer-readable media storing a machine-learned model trained according to any one of, or any combination of, the preceding example implementation(s) of the example method(s).

Example aspects of the present disclosure provide a computing system that implements a machine-learned model trained according to any one of, or any combination of, the preceding example implementation(s) of the example method(s).

Example aspects of the present disclosure provide a computing system that implements a machine-learned model trained according to any one of, or any combination of, the preceding example implementation(s) of the example method(s), wherein the computing system is configured to provide an augmented reality diagnostic tool.

Example aspects of the present disclosure provide a computing system including: one or more processors; and one or more non-transitory computer-readable media storing instructions that are executable by the one or more processors to perform operations, the operations including the method according to any one of, or any combination of, the preceding example implementation(s) of the example method(s).

Example aspects of the present disclosure provide a training dataset constructed according to any one of, or any combination of, the preceding example implementation(s) of the example method(s).

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system according to example implementations of aspects of the present disclosure.

FIG. 2 is an illustration of an example technique for image patch generation at emulated magnifications.

FIG. 3 is a block diagram of an example system according to example implementations of aspects of the present disclosure.

FIG. 4 is a visualization of a cropping technique of an example system according to example implementations of aspects of the present disclosure.

FIG. 5 is a visualization of a labeled image patch processed by an example system according to example implementations of aspects of the present disclosure.

FIG. 6 is a visualization of a labeled image patch processed by an example system according to example implementations of aspects of the present disclosure.

FIG. 7 is a chart of example test results of an example system according to example implementations of aspects of the present disclosure.

FIG. 8 is a chart of example test results of an example system according to example implementations of aspects of the present disclosure.

FIG. 9 is a chart of example test results of an example system according to example implementations of aspects of the present disclosure.

FIG. 10 is a chart of example test results of an example system according to example implementations of aspects of the present disclosure.

FIG. 11 is a chart of example test results of an example system according to example implementations of aspects of the present disclosure.

FIG. 12 is a chart of example test results of an example system according to example implementations of aspects of the present disclosure.

FIG. 13 is a chart of example test results of an example system according to example implementations of aspects of the present disclosure.

FIG. 14 is a chart of example test results of an example system according to example implementations of aspects of the present disclosure.

FIG. 15 is a chart of example test results of an example system according to example implementations of aspects of the present disclosure.

FIG. 16 is a chart of example test results of an example system according to example implementations of aspects of the present disclosure.

FIG. 17 is a chart of example test results of an example system according to example implementations of aspects of the present disclosure.

FIG. 18 is a chart of example test results of an example system according to example implementations of aspects of the present disclosure.

FIG. 19 is a chart of example test results of an example system according to example implementations of aspects of the present disclosure.

FIG. 20 is a visualization of a clustered dataset obtained using an example system according to example implementations of aspects of the present disclosure.

FIG. 21 is a flow chart diagram illustrating an example method for training a machine-learned model according to example implementations of aspects of the present disclosure.

FIG. 22 is a block diagram of an example processing flow for using machine-learned model(s) to process input(s) to generate output(s) according to example implementations of aspects of the present disclosure.

FIG. 23 is a block diagram of an example sequence processing model according to example implementations of aspects of the present disclosure.

FIG. 24 is a block diagram of an example technique for populating an example input sequence for processing by a sequence processing model according to example implementations of aspects of the present disclosure.

FIG. 25 is a block diagram of an example model development platform according to example implementations of aspects of the present disclosure.

FIG. 26 is a block diagram of an example training workflow for training a machine-learned model according to example implementations of aspects of the present disclosure.

FIG. 27 is a block diagram of an inference system for operating one or more machine-learned model(s) to perform inference according to example implementations of aspects of the present disclosure.

FIG. 28 is a block diagram of an example networked computing system according to example implementations of aspects of the present disclosure.

FIG. 29 is a block diagram of an example computing device according to example implementations of aspects of the present disclosure.

FIG. 30 is a block diagram of an example computing device according to example implementations of aspects of the present disclosure.

FIG. 31 is a flow chart diagram illustrating an example method according to example implementations of aspects of the present disclosure.

FIG. 32 is a flow chart diagram illustrating an example method according to example implementations of aspects of the present disclosure.

FIG. 33 is a flow chart diagram illustrating an example method according to example implementations of aspects of the present disclosure.

FIG. 34 is a flow chart diagram illustrating an example method according to example implementations of aspects of the present disclosure.

FIG. 35 is a flow chart diagram illustrating an example method according to example implementations of aspects of the present disclosure.

### DETAILED DESCRIPTION

Generally, the present disclosure is directed to image processing models that can be used to analyze histopathology image data. The present disclosure provides a number of improvements to training and inference of such models that improve performance especially in the histopathology domain.

For example, image processing for pathology applications can involve visual features that are different from most natural images. For instance, pathology images are often in the form of whole slide images (WSIs) which can have a distribution of subjects that is larger than many natural images. For instance, the semantic concepts in pathology span a large range in terms of the resolution and field of view, from patch-level (e.g. specific regions and cellular patterns) to slide-level and case-level concepts (tissue orientation, microenvironment, and cellular and structural interaction).

Deep learning models in histopathology offer promising opportunities for improving diagnosis, clinical research, and precision medicine. However, development of such models is often limited by availability of high quality data. Foundation models in histopathology that learn general representations across a wide range of tissue types, diagnoses, and magnifications offer the potential to reduce the data, compute, and technical expertise necessary to develop task-specific deep learning models with the required level of model performance. The present disclosure describes example developments of machine-learned models for histopathology via self-supervised learning (SSL).

Advantageously, the present disclosure provides improvements to the scalability and generalizability of machine-learned image processing models for histopathology applications. The present disclosure describes improvements to such techniques as self-supervised learning (SSL), which can enable ML models to learn image features without the need for semantic labels acquired through human supervision.

For instance, example implementations of the present disclosure provide data curation techniques for constructing balanced datasets. For some histopathology tasks, some datasets can contain suboptimal diversity of training examples (e.g., diverse types of examples, diverse classification of examples, such as positives and negatives, etc.). Example implementations of the present disclosure can mitigate this imbalance by using the image processing model to cluster and resample its own dataset. For instance, a first training run can be used to obtain sufficient performance to generate embedding representations for the images in the training dataset. These embedded representations can be clustered into groups or clusters. Then representative examples can be sampled from the clusters, and a distribution over the clusters can be enforced in the resulting dataset (e.g., sample from each cluster evenly, sample from larger clusters with a bias different than a bias present in the underlying dataset, etc.). The curated datasets can also include training examples sampled across multiple different magnification levels (e.g., which can be actual magnification levels or emulated magnification levels).

Example implementations of the present disclosure can provide data augmentation techniques for improved self-supervised learning. In some cases, self-supervised learning can force a model to generate like representations for views of the same object or scene, even when changing the view. In this manner, for instance, self-supervised learning can train the model to internalize conceptual or semantic meaning from the images and not be distracted by different views or perspective changes. Example augmentations include simulating out-of-focus histopathology images, stain color variations, cropping with enforced overlap ratios, and combinations thereof.

Example implementations of the present disclosure can leverage new model structures that capture detail across the input image(s) at varying levels of detail. For example, an input image can be parsed into differently sized elements or chunks for processing. The image processing model can generate latent representations describing the image based on internal architectures that reflect information aggregated over the chunks. The image processing model can use one or more of these aggregation units. Each of such aggregation units can aggregate over different spatial scales. For instance, one aggregation unit can aggregate over an entire image portion (e.g., over all chunks of entire image, entire patch of image, etc.). Another aggregation unit can aggregate over a subset of the image portion (e.g., a subset of chunks of image, image patch, etc.). In this manner, for instance, salient details can be processed by the model in varying levels of detail.

Technical effects and benefits of the present disclosure can include improved accuracy or quality of the image processing model; reduced energy consumption; reduced training costs and training time; optimizing with limited or no downstream task data; greater data efficiency in downstream fine-tuning; and improved versatility of a pretrained image processing model.

Example implementations of the present disclosure can improve the accuracy and output quality of an image processing model by curating a more balanced dataset compared to previous methods. By increasing the quality of the training dataset, a resulting trained machine-learned model can achieve better performance or quality with less training data or fewer training iterations.

Additionally, example implementations of the present disclosure can improve the versatility of a pre-trained image processing model. In some instances, a pre-trained image processing model can be capable of performing a plurality of downstream tasks. In some instances, a pretrained image processing model can later be fine-tuned using downstream task data. In other instances, a pretrained image processing model can perform a downstream task without the need for fine-tuning. This versatility can enable reduced energy usage and training costs, such as by enabling the use of one optimized primary model for multiple tasks.

An example technical effect of example implementations of the present disclosure is increased energy efficiency in performing operations using machine-learned models, thereby improving the functioning of computers implementing such models. For instance, example implementations can provide for more energy-efficient training operations or model updates by curating an improved training dataset, creating more informative training examples with improved data augmentations, and leveraging powerful cross-scale aggregation units. In some scenarios, increased energy efficiency can provide for less energy to be used to perform a given number of update iterations (e.g., less energy expended to maintain the model in memory, less energy expended to perform calculations within the model, such as computing gradients, backpropagating a loss, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

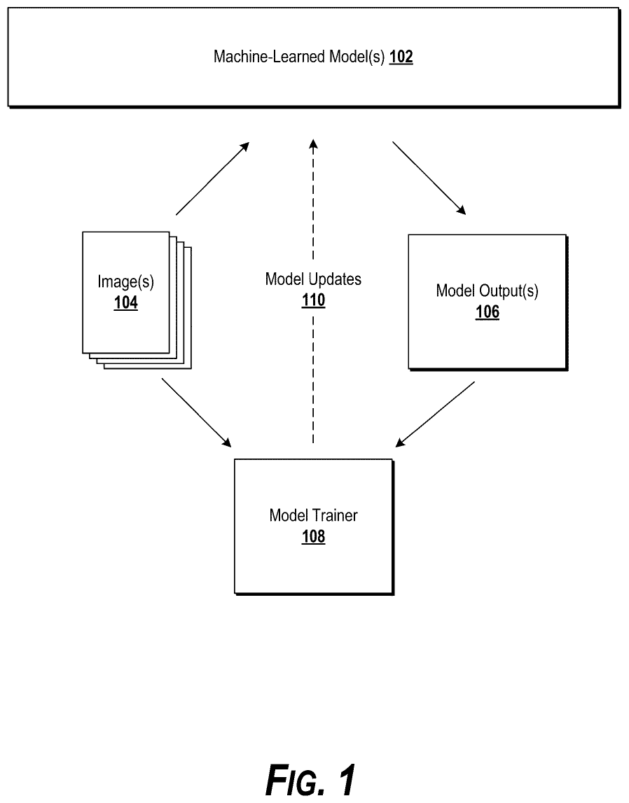

FIG. 1 is a block diagram of an example system for executing and training machine-learned models according to example aspects of the present disclosure. In an example, machine-learned image processing model(s) 102 can process images 204 (e.g., histopathology images) to generate model output(s) 106. Model trainer 108 can process model output(s) 106 and the original images 104 (e.g., histopathology image(s)) to generate model update(s) 110 for training machine-learned image processing model(s) 102.

Machine-learned model(s) 102 can include machine-learned image processing models. Machine-learned model(s) 102 can include machine-learned embedding models that generate embeddings based on input data (e.g., input images, input audio, input text, etc.). Example aspects and implementations of machine-learned model(s) 102 are described below with respect to machine-learned model 1. For instance, in an example, machine-learned model(s) 102 include a machine-learned sequence processing model. For example, machine-learned model(s) 102 can include one or more self-attention or cross-attention architectures (e.g., a transformer block) that can generate portions of a sequence of data elements based on a context window containing other portions of the sequence of data elements.

Image(s) 104 can include image data, such as single or multichannel pixel data. The images can include histopathology imagery, such as slide imagery.

Model output(s) 106 can include an embedding output. Model output(s) 106 can include a classification output. Model output(s) 106 can include a summarization output. Model output(s) 106 can include a regression output quantifying a characteristic of image(s) 104. Additional example tasks and outputs are described below with respect to machine-learned model 1.

Model trainer 108 can be or include or be implemented by a computing system configured to provide inputs to machine-learned model(s) 102 and evaluate outputs from machine-learned model(s) 102 to provide model update(s) 110.

Model update(s) 110 can be or include updates to learnable parameters of machine-learned model 102. Model update(s) 110 can be or include updates to learnable hyperparameters of machine-learned model 102 or training hyperparameters of model trainer 108.

Model trainer 108 can access a training dataset that contains image(s) 104. Images 104 can include a mixture of image attributes. An example attribute includes magnification or zoom.

Magnification or zoom can be defined with respect to a reference. In general magnification can be defined as a ratio of apparent size to actual size. The apparent size can be measured as apparent to an eye or an imaging sensor. For instance, a reference can be a life-size reproduction. An example reference life-size reproduction ratio for an imaging system can be when imaging optics project a projected image of a subject onto an imaging sensor, wherein a feature on the subject measured in the focal plane is the same size as the feature measured in the projected image.

A mixture of magnifications can be obtained by recording images at a mixture of magnification ratios (e.g., with various different optical configurations on an imaging device). A mixture of magnifications can include a mixture of images, each recorded at a different native magnification.

A mixture of magnifications can be synthesized. For example, a mixture of magnifications can be synthesized by transforming an original image (e.g., an image having a native magnification) to emulate various different recording magnifications.

A mixture of magnifications can be obtained by sampling examples of different magnifications to compile examples for a training dataset. Sampling across magnifications can include randomly sampling training examples from different magnification classes. For instance, a full training dataset can include histopathology images captured or scanned at various levels of magnification. A training dataset of image patches can be constructed by sampling from the respective magnification bins in the full dataset. For instance, a full dataset can include a bin for 5× magnification examples, a bin for 10× magnification examples, a bin for 20× magnification examples, etc. A training dataset can be constructed by sampling examples from each bin according to some prior distribution (e.g., with equal probabilities, with different probabilities, etc.). In this manner, for instance, training examples can reflect different native magnification levels.

Sampling across magnifications can include generating training examples that provide different effective magnification. For instance, a slide image scanned at 20× magnification can be used to emulate one quarter of an image of the same slide scanned at 10× magnification. Accordingly, an image can provide a patch at native magnification by mapping pixels in the image to pixels in the patch at a unity ratio. The same image can provide a patch at a higher emulated magnification by mapping pixels in the image to pixels in the patch at a ratio less than unity (e.g., a patch of a given dimension can cover a smaller area of the original specimen to emulate a higher magnification). The same image can provide a patch at a lower emulated magnification by mapping pixels in the image to pixels in the patch at a ratio greater than unity (e.g., a patch of a given dimension can cover a larger area of the original specimen to emulate a lower magnification). Mapping at ratios greater than unity can be implemented by downsampling, subsampling, etc., including using machine-learned models to generate an output image at an output resolution based on an input image at a different input resolution. Mapping at ratios less than unity can be implemented by upsampling, oversampling, etc., including using machine-learned models to generate an output image at an output resolution based on an input image at a different input resolution. Various machine-learned models can include transformer-based models, convolutional neural networks, diffusion-based models, etc.

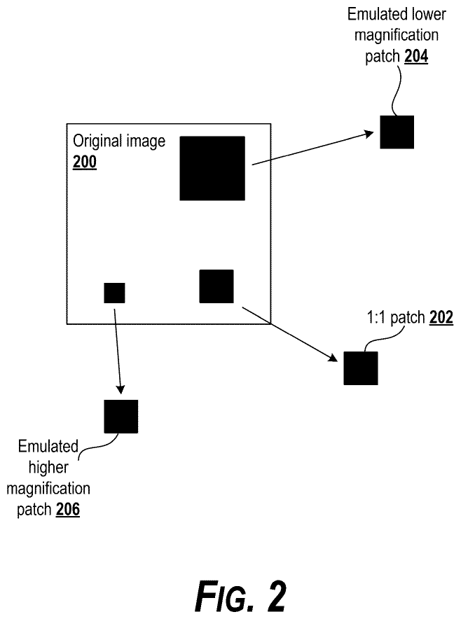

FIG. 2 is an illustration of an example technique for image patch generation at emulated magnifications. An original image 200 can be access at a native resolution. Patches of the original image can be extracted for input to an image processing model. A 1:1 patch 202 can be extracted at a native resolution (e.g., the same resolution as original image 200) to provide a patch representing native magnification of original image 200.

A patch can be configured to align with an input dimension of machine-learned model 102 (e.g., a height/width of an input layer, a token size, an integer multiple of a token size, etc.). The input dimension can correspond to an image size. By resizing various image patches to conform to the input dimension, the patches can provide different apparent magnifications to the machine-learned model.

In an example, a native magnification baseline corresponds to an input dimension of machine-learned model 102. For instance, in an examples, an input layer is configured to receive 256 pixel by 256 pixel image patches, and a dataset of original images includes original images having a size of at least 256 pixels by 256 pixels.

To provide a patch at a native magnification, a 256 by 256 crop can be extracted from the original image. For instance, a crop can provide a 1:1 patch 202, in which pixels in the cropped patch have a 1:1 correspondence to pixels in the original patch such that the patch provides a 1:1 magnification ratio as compared to the original image.

To emulate a patch at non-native magnifications, a portion of the original image that is not the same size as the input dimension(s) can be resampled/regenerated into a patch that does align with the input dimension(s).

For example, to emulate a lower magnification than the native magnification, a portion of the original image having a dimension larger than the input dimension can be resampled/regenerated to form an emulated lower magnification patch 204 that has dimension(s) aligned to the input dimension(s). In this manner, for instance, the field of view within the output patch can cover more area of the subject/object (or depict the subject as smaller, on a pixel basis, as compared to original image 200), thereby emulating an image capture at a lower magnification.

In another example, to emulate a higher magnification than the native magnification, a portion of original image 200 having a dimension smaller than the input dimension can be resampled/regenerated to form an emulated higher magnification patch 206 that has dimension(s) aligned to the input dimension(s). In this manner, for instance, the field of view within the output patch can cover a smaller area of the subject/object (or depict the subject as larger, on a pixel basis, as compared to original image 200), thereby emulating an image capture at a higher magnification.

In some situations, a resampled/regenerated image at an output resolution can have better quality than a native image at the output resolution. For example, a resampled/regenerated process can correct for, smooth over, decode, etc. noise or other artifacts present in the native image capture. Such noise or artifacts can be added back into the resampled/regenerated patch to emulate a native capture at the patch resolution. A machine-learned model can be trained to generate realistic noise or other artifacts to inject into the patch. The model can be trained using a training dataset containing clean images and versions of the clean images with noise. Noise can be added using a compression algorithm. For example, a compression algorithm can be applied to introduce noise. An example compression algorithm is JPEG image compression.

Machine-learned super-resolution or denoising models can be used to increase a resolution of the portion of the image.

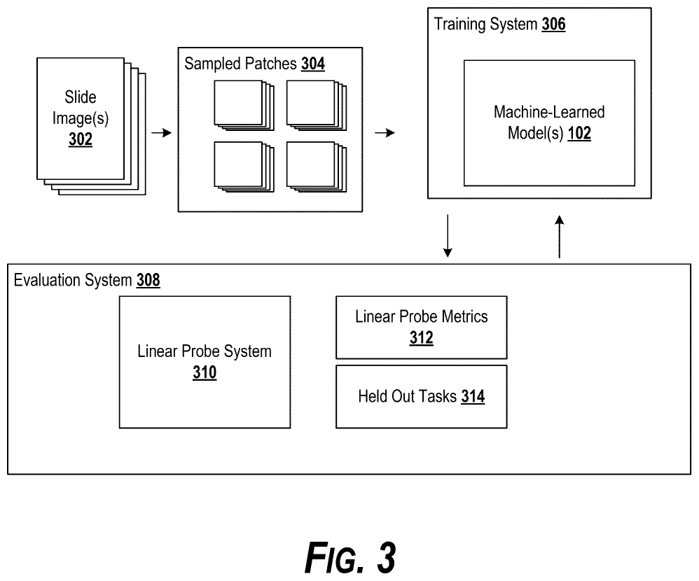

FIG. 3 is a block diagram of an example system for executing and training machine-learned models according to example aspects of the present disclosure. A test system constructed according to FIG. 3 was used to obtain measured results as described further herein.

Slide image(s) 302 can be or include images of histopathological or dermatological slides to provide example training data. Example training data included hematoxylin and eosin stained (H&E) WSIs from The Cancer Genome Atlas (TCGA). TCGA is organized into individual studies representing different cancer types and images from 32 TCGA studies were included for training. Frozen slides from TCGA were excluded to maximize training on H&E images from formalin-fixed paraffin-embedded (FFPE) tissue (e.g., a common intended target of downstream applications). In the present Example Experiments, TCGA data was also limited to images scanned at 20X as this is the highest magnification available for all TCGA studies. We did not use images scanned at 40× as this magnification is only available for a subset of the TCGA studies. Limited availability of 40× magnification can introduce bias in terms of specific sites and scanners. Available WSIs were split into train (n=6249), tune (n=3079) and test splits (n=3065) by case to avoid any overlap of SSL training slides with slides in any downstream test sets containing TCGA data. For SSL model training, 60 million image patches (either 256×256 pixels or 512×512 pixels) were randomly sampled from the train split (with additional sampling variations as described herein). To develop models robust to differences in magnification (e.g., resolution or “zoom”), patches were sampled evenly across multiple magnifications, including 5× (˜2 μm/pixel), 10× (˜1 μm/pixel), and 20× (˜0.5 μm/pixel).

Sampled patches 304 can include the patches sampled from slide image(s) 302.

Training system 306 can operate to train one or more machine-learned models based on slide image(s) 302. Training system 306 can train, for instance, machine-learned model 102.

The measured example implementations of machine-learned model 102 provided herein focused on utilization of a Vision Transformer (ViT) backbone (ViT-S and ViT-B), with two different self-supervised learning (SSL) methods: SimCLR (Chen et al., “A Simple Framework for Contrastive Learning of Visual Representations,” arXiv:2002.05709v3 [cs.LG]1 Jul. 2020) and MSN (Assran et al., “Masked Siamese Networks for Label-Efficient Learning,” arXiv:2204.07141v1 [cs.LG]14 Apr. 2022) as representative contrastive and non-contrastive SSL approaches, respectively. The ViT backbone with SimCLR and MSN provide our baseline SSL models (“SimCLR-base” and “MSN-base” respectively). These baseline SSL models utilized the ViT-S/16 backbone, taking input image patches of 224×224 pixels (14×14 ViT patch tokens of 16×16 pixels each; output embedding vector of size 384 for each input image patch). Encoder backbones were initialized with weights from a ViT-S/16 trained on ImageNet-21k via the AugReg approach. Final training details and hyperparameters for the baseline models are provided in Table 1.

TABLE 1
Training details and hyperparameters for SSL base models

| Shared hyperparameters | SimCLR/MSN-base |
|---|---|
| Backbone | ViT-S/16 |
| Pretrained checkpoint | AugReg ImageNet-21k |
| Original image patch size | 256 |
| Color distortion (brightness, | 0.4, 0.4, 0.4, 0.1 |
| contrast, saturation, hue) | |
| Projection head | Three layer network with dimensions of |
| | 2048 × 256 × 1024 (input to output). |
| Batch size | 1024 |
| Optimizer | AdamW |
| Learning rate | 1e−4 (SimCLR) or 1e−3 (MSN) |
| | with linear warmup |
| | and cosine decay to 1e−6. |
| Weight decay rate | Initial rate of 0.04 with reverse |
| | cosine decay to 1. |
| Training epochs | 5 |

| SimCLR hyperparameters | SimCLR-base |
|---|---|
| NT-Xent temperature | 0.1 |
| Image crop size (Inception-style) | 224 |
| Crop area percentage | Uniform over [30%, 100%] |

| MSN hyperparameters | MSN baseline |
|---|---|
| Global crop size | 224 |
| Global crop area percentage | Uniform over [30%, 100%] |
| Number of global views | 1 teacher, 1 student |
| Local crop size | 96 |

| Shared hyperparameters | SimCLR/MSN-base |
|---|---|
| Local crop area percentage | Uniform over [5%, 30%] |
| Number of local views | 10 student |
| Mask percentage | 25% |
| Sinkhorn Norm | Yes |
| Centering | No |
| Cross-entropy teacher temperature | 0.0125 |
| Cross-entropy student temperature | 0.1 |
| ME-MAX temperature | 0.1 |
| Student to teacher EMA rate | Initially 0.996 with cosine decay. |

Following establishment of the baseline SSL models, we explored a number of pathology-motivated methodological variations to further optimize SSL for histopathology. These included data augmentations, data sampling, training loss variations and the use of center embeddings. Details on these specific methods are described below. These variations were first added to the baseline SSL models individually. Variations that led to improvements were combined to produce our final SSL models. For combining individual variations, hyperparameters specific to each variation were re-tuned, and may differ from those selected for use of the individual variations alone.

### Data Augmentations—Color Augmentation

We utilized RandStainNA as it showed improved downstream performance in pilot experiments when used in conjunction with the typical color jittering operations of SSL data augmentation. Briefly, for every image, RandStainNA picks one of three color spaces—LAB, HSV, HED—uniformly at random, and applies the Reinhard transformation to fit the first and second-order color statistics of the image in the sampled color space to a target template. This target template is a sample from per-channel Gaussian fits to the color statistics from a random selection of training images in their respective color spaces.

### Data Augmentations—Poisson Noise and JPEG Artifacts

While application of blurring as a data augmentation strategy in pathology images can simulate out-of-focus patterns in pathology imaging (in addition to potentially encouraging the learning of higher-order structure or morphology), it also smooths away the natural artifacts of digital pathology imaging that arise from sensor noise and image compression. In consideration of these natural artifacts, we explore an additional data augmentation method where we apply Poisson noise and JPEG artifacts (through an encode-decode step) after the application of Gaussian blur. Our hypothesis is that simulating such natural sources of noise during SSL might improve pathology-specific feature learning and enable additional robustness for downstream inference tasks. Poisson noise and JPEG artifact augmentations were also explored separately during exploration of individual and combined improvements for final models.

### Data Curation

To balance the original training dataset, we applied a cluster-based sampling approach. We trained an initial SSL model on the 60 million patch training dataset. Patch-level embeddings from this initial SSL model were used to define clusters using k-means clustering (using cosine distance as the similarity metric). All patches in the initial training dataset were assigned to the clusters. Then a new dataset was generated by sampling a fixed number of patches from each cluster for a total of 6 million patches. A new SSL model was trained on this cluster-balanced dataset.

In initial experiments, we explored different numbers of clusters (between 1000 and 20000) and found k=12000 to result in best patch-level linear probe tune set performance. We also explored applying a second iteration of clustering and re-sampling based on the model from the first iteration, but did not observe any additional benefit. The best performing configuration was used for combining with the other training variations.

### Overlap in Image Crops

Since semantic content in pathology image patches can potentially have a different spatial distribution than is found in natural image datasets, we explored modifications to the typical crop-and-resize data transformation in SSL approaches. In traditional approaches, crops are generally randomly sampled from the image without consideration of overlap, since object-centric natural image datasets tend to exhibit a center-bias, which is likely to capture related semantic content in all crops. We experimented with different degrees of overlap between crops used in the SSL training process. In particular, we ran a grid search where we explored a range of enforced overlap between crops (see Table 2) in the training configurations for both SimCLR and MSN approaches.

Table 2 further provides example hyperparameters used in various implementations.

TABLE 2
Training details and hyperparameters for SSL individual improvements

| | | | Final best value |
|---|---|---|---|
| | | Hyperparameter | (independent of other |
| Improvement | Hyperparameter | range | improvements) |
| RandStainNA | Color jitter strength | Weak (0.2, 0.2, 0.2, | Moderate |
| | (brightness, contrast, | 0.05), moderate (0.4, | |
| | saturation, hue) | 0.4, 0.4, 0.1), strong | |
| | | (0.8, 0.8, 0.8, 0.2) | |
| | Color jitter probability | 0, 0.8, 1 | 0.8 |
| | Staining probability | 0, 0.8, 1 | 0.8 |
| PathBlur | Add Poisson noise | False, True | True |
| | Add JPEG artifacts | False, True | True |
| Data curation | Number of clusters | [500, 1k, 2k, | 18k |
| | | 4k, . . . , 20k] | |
| | Number of K-Means | 1M, 2M | 1M |
| | training samples | | |
| | Number of sampled | 6M, 12M, 24M | 6M |
| | curated patches for SSL | | |
| | training | | |
| Overlap | Min. overlap area (%) | 0.01, 0.05, 0.1, 0.2 | 0.2 |
| cropping | | | |
| | Input patch size | 256, 512 | 256 |
| Hard negative | Reweight beta | 0.01, 0.02, 0.05, | 0.1 |
| mining | | 0.1, . . . , 2.0 | |
| Hybrid loss | Global only (not using | False, True | True |
| | local views) | | |
| | SimCLR loss weight | 0.5, 1 | 1 |

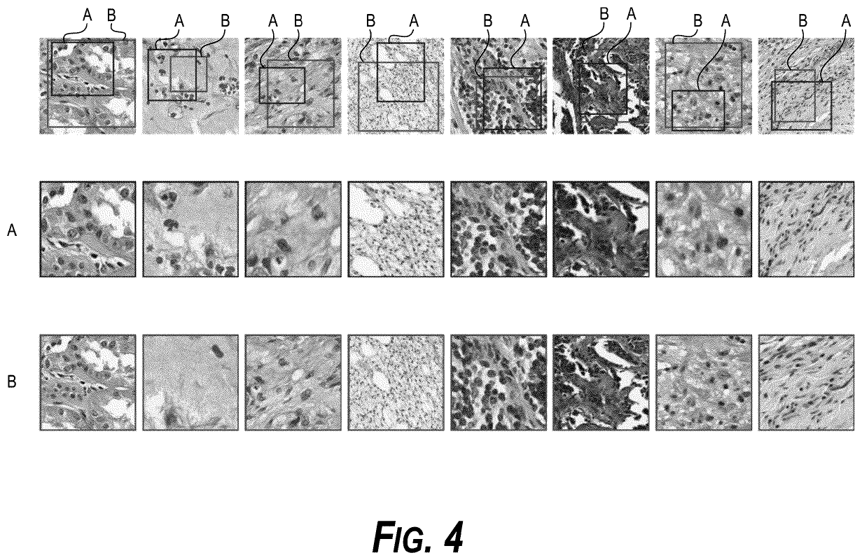

FIG. 4 provides a visualization of an input image cropping approach. The top row illustrates that, from within a sampled input patch, a global crop can be randomly selected (rectangles B), followed by a local crop (rectangles A), to achieve a threshold proportion of overlap. In the example illustrated, at least 20% of the area of the global crop is included within the local crop. The extent of overlap for optimal performance in this particular example on the linear probe metric was found via grid-search. Other search algorithms may be used to optimize the overlap proportion in other implementations. The global crops [middle row] or local crops [bottom row] are shown when resized to 224×224, to be used as input images for training the SSL model (before applying other data transformations).

### Training Loss Variations—Hard Negative Mining (Re-Weighting Loss)

We explore the use of hard negative mining in our SimCLR loss (NT-Xent) using a reweighting method. Briefly, the method works by using importance sampling on the set of negative images for an anchor image, up-weighting instances that are harder to separate from the anchor at any stage of training. We ramp up the strength of up-weighting across training steps, starting from an initial condition of no re-weighting.

### Training Loss Variations—SimCLR-MSN Hybrid Loss

In initial experiments, we noticed a trend of SimCLR sometimes performing better in tasks with more granular regions of interest (e.g. lung histologic subtyping and mitotic figure detection), whereas MSN sometimes performed better at the less granular tasks (e.g. TCGA study types and tertiary teaching hospital tissue types). In some trials, a SimCLR loss (NT-Xent) was added to the MSN training. For example, in one implementation, each pair of teacher and student global views in the MSN training were treated as positive pairs in a batch with the rest of the batch's teacher and student global views serving as negative examples. We also tested using global and local views of the same image as positive pairs.

### Center Embeddings

For some patch-level prediction tasks, the patch-level label only applies to the center of the patch, while the area around the center provides useful context to the model for making a prediction.

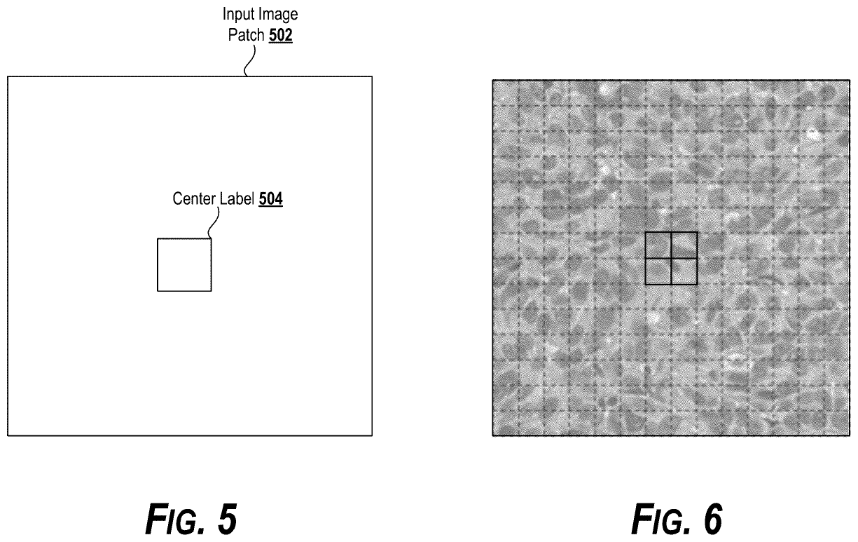

FIG. 5 is a diagram of an example patch. For example, an input image patch 502 can correspond to a center label 504.

FIG. 6 is a visualization of how the center patch label corresponds to a tokenized representation of the image. For example, the locations of embeddings corresponding to 16×16 pixel “tokens” within the original input patch are shown in FIG. 6. In FIG. 6, an example 224×224 pixel input image patch is depicted with the dashed lines representing the input patch tokens to machine-learned model 102 (e.g., a vision transformer) (16×16 pixels) that include each input image. Outlines indicate the center 2×2 patch tokens. The output of machine-learned model 102 contains embeddings for each of the input tokens as well as an embedding of a “class token” that represents the entire input patch.

Since the class token embedding of the ViT model can be essentially an aggregate of image token embeddings, we explored whether the center token embeddings can be used to provide additional predictive value. Specifically, we explored whether an average pooling of the center N×N token embeddings would improve the performance of our linear probe tasks, either concatenated with the standard class token embedding or used in isolation.

Training system 306 can train machine-learned model(s) 102 over a sampled patches 304 using a self-supervised training technique according to example implementations of the present disclosure.

Evaluation system 308 can be configured to evaluate the performance of the trained machine-learned model 102.

### SSL Model Evaluation

Model evaluation was composed of four steps including both patch-level and weakly supervised slide-level or case-level tasks. First we established a benchmark set of 11 patch-level tasks to be used for both model tuning and linear evaluation. This included nine tissue-specific tasks (over six unique tissues) and two multi-tissue classification tasks, together spanning different optimal magnifications and task types. The tasks can be linear probing tasks conducted by evaluation system 308 using linear probing system 310. Second, we evaluated models via linear probing (e.g., using linear probe system 310) on mitotic figure identification in melanoma and breast cancer, representing held-out patch-level tasks 314 (e.g., using patches not included in SSL model tuning). Third, to further evaluate generalization of the representations learned by the SSL models, we performed linear evaluation on a diverse set of additional held out, weakly supervised tasks. Fourth, we evaluated data efficiency and performance when fine-tuning end to end with SSL pre-training for two patch-level tasks. The performance on the tasks are measured using linear probing metrics 312.

Details of the tasks are provided in Table 3.

TABLE 3
Linear probe tasks and datasets

| | | | Tissue | Task | Slides | Datasource |
|---|---|---|---|---|---|---|
| Task name | Description | Classes | type | type | (train/tune/test) | reference |
| Breast IC | Breast | Benign, | Breast | Tumor | 573/288/669 | Jaroensri et |
| | invasive | Invasive | | detection | | al. |
| | carcinoma | Carcinoma, | | | | |
| | detection | DCIS | | | | |
| Breast NP | Breast cancer | NP1, NP2, NP3 | Breast | Tumor | 681/343/945 | Jaroensri et |
| | nuclear | | | grading | | al. |
| | pleomorphism | | | | | |
| | grading | | | | | |
| Breast TF | Breast cancer | TF1, TF2, TF3 | Breast | Tumor | 681/343/945 | Jaroensri et |
| | tubule | | | grading | | al. |
| | formation | | | | | |
| | grading | | | | | |
| CAMELYON16 | Breast cancer | Tumor, Non- | Lymph | Tumor | 216/54/258 | Liu et al. |
| | detection in | Tumor | node | detection | | Benjordi et |
| | lymph nodes | | | | | al. |
| Lung AD | Lung | Acinar, | Lung | Tumor | 73/25/50 | Sadwhani |
| | adenocarcinoma | Cribriform, | | subtyping | | et al. |
| | histologic | Lepidic, | | | | |
| | subtypes | Micropapillary, | | | | |
| | | Papillary, | | | | |
| | | Solid, | | | | |
| | | Leukocyte, | | | | |
| | | Necrosis, Non | | | | |
| | | Tumor | | | | |
| CIN | Cervical | Non-tumor, | Cervix | Tumor | 329/74/229 | N/A |
| | dysplasia | CIN 1, CIN 2+ | | grading | | (see |
| | grading | | | | | methods) |
| CRC | Colorectal | Tumor, Non- | Colon and | Tumor | 149/51/44 | Wulczyn et |
| | carcinoma | tumor | Rectum | detection | | al. |
| | detection | | | | | |
| Gleason | Prostate | Benign, GP3, | Prostate | Tumor | 178/85/88 | Nagpal et |
| NCB | cancer | GP4, GP5 | | grading | | al. |
| | Gleason | | | | | |
| | grading on | | | | | |
| | needle core | | | | | |
| | biopsies | | | | | |
| Gleason RP | Prostate | Benign, GP3, | Prostate | Tumor | 550/259/202 | Nagpal et |
| | cancer | GP4, GP5 | | grading | | al. |
| | Gleason | | | | | |
| | grading on | | | | | |
| | radical | | | | | |
| | prostatectomies | | | | | |
| Tissue type | Tissue Type | Appendix, | 16 | Tissue type | 17319/6488/6719 | Weng et al. |
| | | Breast, Cervix, | | classification | | |
| | | Colon and | | | | |
| | | rectum, | | | | |
| | | Fallopian Tube, | | | | |
| | | Gallbladder, | | | | |
| | | Liver, Lymph | | | | |
| | | node, Ovary, | | | | |
| | | Placenta, | | | | |
| | | Prostate, Skin, | | | | |
| | | Thyroid, Upper | | | | |
| | | GI, Uterus, Vas | | | | |
| | | deferens | | | | |
| TCGA | TCGA study | TCGA studies: | 10 | Tissue type | 2952/1466/1489 | N/A |
| study type | type | BLCA, BRCA, | | classification | | (see |
| | | COAD, HNSC, | | | | methods) |
| | | KIRC, LIHC, | | | | |
| | | LUAD, LUSC, | | | | |
| | | OV, STAD | | | | |

Abbreviations:
GP: Gleason pattern;
IC: Invasive Carcinoma;
NP: nuclear pleomorphism;
TF: Tubule formation;
DCIS: Ductal carcinoma in situ;
CIN: Cervical intraepithelial neoplasia

### Patch-Level Linear Probing

We selected a set of 11 patch-level tasks for linear probe evaluation (Table 3) with rigorously curated data sets spanning a diversity of task types, tissue types, and magnification requirements. Most of the datasets have been previously described (with references also included in Table 3). The cervical dysplasia data is a pathologist annotated dataset from the same tertiary teaching hospital as the breast cancer tasks. Because TCGA is the primary training datasource for our SSL models, when necessary, new train/tune/test splits were generated in order to create test splits that did not include any TCGA data. The one exception is the TCGA study type task, for which the SSL train/tune/test splits were used (ie. no cases used for SSL training were included in the study type test set).

These 11 tasks were used to compute a single aggregated patch-level “linear probe metric”. As used in this test, linear probing involves fitting a linear model on SSL model patch embeddings to predict patch-level labels. All tasks were framed as classification tasks and evaluated using the area under the receiver operating characteristic curve (AUC) achieved by a regularized logistic regression model. For tasks with more than two classes, the macro-averaged AUC was used. The logistic regression models were initially trained on 10000 patches from the train split and evaluated on 5000 patches from the tune split. 5-fold cross-validation (stratified by slide) on the train patches was used to select L2 regularization weights. Since task performance is dependent on magnification, each task was evaluated at three magnification levels (5×, 10×20×) and the highest AUC across magnifications was chosen. Finally a weighted average of these best task-specific AUCs was used to arrive at a composite “linear probe metric”. Task weights were selected to distribute weights over tissue types and tasks, as detailed in Table 4.

TABLE 4
Weights per task for weighted average linear probe metric

| | Relative | Tissue |
|---|---|---|
| Task name | Weight | type |
| Breast Inv Car | 0.33 | Breast |
| Breast NP | 0.33 | Breast |
| Breast TF | 0.33 | Breast |
| CAMELYON16 | 1 | Lymph node |
| Lung AD | 1 | Lung |
| CIN | 1 | Cervix |
| CRC | 1 | Colon |
| Gleason NCB | 0.5 | Prostate |
| Gleason RP | 0.5 | Prostate |
| Tissue type | 0.5 | Multi |
| TCGA study | 0.5 | Multi |
| type | | |

Linear probe metrics on the tune sets were used to guide model selection. Tune set metrics were used to select two final embedding approaches, using SimCLR and MSN, respectively. Then, individual training variations (see Methods for individual variations below) were evaluated and those achieving improvements of greater than three standard deviations over the respective baseline model were selected for combined optimization, as detailed in Table 5. Optimization of combined individual improvements led to selection of the “best” models (SimCLR-best and MSN-best).

TABLE 5
Evaluation of individual training variations for optimizing
a pathology trained SSL model (tune set)

| | Linear probe avg AUC | | | |
|---|---|---|---|---|
| | | Delta vs | | Delta vs |
| Method | SimCLR | baseline | MSN | baseline |
| Baseline (average of 5 runs) | 93.36% | — | 93.22% | — |
| ViT-B | 93.58% | 0.22% | 93.52% | 0.30% |
| Data sampling via clusters | 93.50% | 0.14% | 93.30% | 0.08% |
| RandStainNA | 93.61% | 0.25% | 93.90% | 0.68% |
| PathBlur (Poisson + JPEG) | 93.46% | 0.10% | 93.56% | 0.34% |
| Overlap cropping | 93.68% | 0.32% | 93.42% | 0.20% |
| Add SimCLR loss | N/A | N/A | 93.55% | 0.33% |
| SimCLR loss w/re-weighting | 93.41% | 0.05% | 93.66% | 0.44% |
| Patch size 512 | 93.68% | 0.32% | 93.25% | 0.03% |
| Center embeddings | 93.70% | 0.34% | 93.59% | 0.37% |

*SimCLR standard deviation: 0.035%; MSN standard deviation: 0.061%. Delta over baseline results are in bold if greater than 3 standard deviations above the respective baseline's average.

Linear probe metrics on the test sets using 5000 patches were used to evaluate the all models. Ablation experiments exploring the impact of various individual parameters were also performed via linear evaluation using the test sets.

### Mitotic Figures and Center Embeddings

To evaluate generalization of these models to a “high magnification task” we used mitotic figure detection in breast cancer and melanoma, for which computer vision approaches often perform optimally using input patches at 40× magnification. These tasks were not included in the main linear probe benchmark to avoid biasing towards optimization of these particular tasks which had lower performance and higher variability than the other tasks in initial exploratory experiments. The data used for mitotic figure detection in breast cancer has been described previously with brief details in Table 6.

TABLE 6
Datasets for mitotic figure tasks

| | | | | Slides |
|---|---|---|---|---|
| | | | Tissue | (train/ |
| Task name | Description | Classes | type | tune/test) |
| Breast MF | Breast mitosis | Negative, | Breast | 573/288/669 |
| | detection | Mitotic | | |
| | | Figure | | |
| Melanoma MF | Melanoma mitosis | Negative, | Skin | 310/93/107 |
| | detection | Mitotic | | |
| | | Figure | | |

Abbreviations:
MF: Mitotic figure

The dataset for melanoma represents an additional dataset from the same tertiary teaching hospital and with the same annotation method as for the breast cancer dataset, consisting of 175 cases split into train:tune:test sets in a 2:1:1 ratio. Due to the nature of the task (high magnification), the use of the center embeddings was also utilized when evaluating mitotic figure detection.

Linear evaluation for mitotic figure detection was conducted similarly to the patch-level linear probe described above, with an average AUC over both tissue types calculated for each model.

### Weakly Supervised Linear Evaluation

Models were further evaluated on weakly supervised tasks using available slide-level or case-level labels. These weakly supervised tasks include gene expression, survival prediction, TCGA study type, ER status for breast cancer, EGFR mutation status for lung cancer, and MSI status for colorectal cancer. TCGA images and data were used for all weakly supervised tasks reported here with the goal of reporting benchmark weakly supervised tasks that can be evaluated by other research groups as well. The same case-level splits for the SSL training were used here, such that the weakly supervised test sets represent held out cases not used for model development. Based on preliminary experiments, 1000 patches per case were sampled randomly and the corresponding patch-level embeddings from the SSL models were aggregated for use in linear evaluation. (Note that most TCGA cases have a single FFPE WSI, but there are cases with more than one FFPE WSI). Average pooling with linear evaluation was used in this work as an initial strategy to evaluate model representations independently from optimization of different possible slide-level or case-level models. All weakly supervised tasks were framed as classification tasks and were evaluated using AUC.

For gene expression prediction tasks, we focused on sets of genes for which feasibility of morphology based gene expression prediction in breast cancer and liver cancer has been reported previously. AUC was calculated per gene for binary classification, using per gene median expression as the threshold (RSEM-based RNAseq data as available via TCGA). The AUCs for each gene were averaged over defined gene sets as listed in Table 7. Gene expression was only evaluated within the relevant TCGA study type (eg. breast cancer gene sets were only evaluated using TCGA BRCA data).

TABLE 7
Gene sets used for weakly supervised experiments

| LIHC set 1 | LIHC set 2 | BRCA set 1 | BRCA set 2 |
|---|---|---|---|
| (Schmauch et al.) | (Xie et al.) | (Wang et al.) | (Mondol et al.) |
| CD3D | CYP3A4 | ADAM33 | BCL2 |
| CD3E | CYP1A2 | AURKA | CCNE1 |
| CD3G | GLUL | BIRC5 | CDC20 |
| CD247 | CYP2E1 | CCNB2 | CDCA7 |
| CD19 | FABP1 | CDC20 | CENPA |
| MS4A1 | | CDC45 | CMC2 |
| MKI67 | | CDCA5 | ESR1 |
| | | CDCA8 | FOXA1 |
| | | CENPA | KIF2C |
| | | DACT3 | MAPT |
| | | E2F2 | MLPH |
| | | KIF2C | MSANTD3 |
| | | KPNA2 | MYBL2 |
| | | MCM10 | NAT1 |
| | | MYBL2 | PGR |
| | | NCAPG | PTTG1 |
| | | NCAPH | SCUBE2 |
| | | NDC80 | SLC39A6 |
| | | ORC1 | SLC7A5 |
| | | PLK1 | UBE2C |
| | | PODN | |
| | | PRR11 | |
| | | SFRP2 | |
| | | SKA1 | |
| | | TROAP | |

For ER status, AUC was calculated for classification of ER positive or negative using TCGA BRCA cases based on biomarker status labels. For survival prediction tasks, AUC for predicting survival greater than 5 years was calculated and averaged across 8 TCGA study types with at least 50 examples in each class (KIRC, SARC, BRCA, LGG, HNSC, UCEC, LUSC, SKCM). For weakly supervised TCGA study type prediction, we evaluated macro-averaged AUC for the same 10 TCGA studies described in Table 1 for the patch-level version of the task and separately for all 32 TCGA studies. For EGFR status prediction, the AUC was calculated for presence of a pathogenic EGFR mutation in LUAD cases, using the somatic mutation calls available in TCGA and manual pathologist annotation for pathogenicity. For MSI status, the AUC was calculated for classification of MSI-H using available MSI status from TCGA.

### Fine-Tuning and Data Titration

To evaluate data efficiency of SSL pre-training and task-specific fine-tuning, we performed experiments for two well established tasks: prostate cancer Gleason grading in needle core biopsies and detection of metastatic breast cancer in lymph nodes. Fine tuning was performed using either supervised ImageNet-21K pre-training or SSL pre-training (SimCLR-best and MSN-best) using different fractions of WSIs in the training data (0.125, 0.25, 0.5, 1.0). The number of slides in the full train splits for these tasks is shown in Table 1. For each titration point, five random subsamples of the training set WSIs were sampled. For each of the five subsamples per data titration point, models were fully fine-tuned on 5 million sampled patches (class-balanced). The hyperparameters for fine-tuning are summarized in Table 8.

TABLE 8
Hyperparameters for data efficiency experiments

| Hyperparameter | Values |
|---|---|
| Magnification | CAMELYON16: 20×, Gleason |
| | NCB: 10× |
| Patch size | 224 × 224 |
| Batch size | 2048 |
| Image | Rotate, Flip |
| Perturbations/Augmentations | |
| Optimizer | Adam |
| Initial learning rate | 0.0001, 0.00001 |
| Learning rate decay steps | 100 |
| Learning rate decay rate | 0.9, 0.95 |
| Max train steps | 10000 |

### Metrics and Statistical Analysis

Confidence intervals for linear probe and weakly supervised tasks were generated via bootstrap resampling over test set slides (as a more conservative approach than resampling over patches) with 1000 replicates. Linear probing used 5000 test set patches per task for each replicate. Weakly supervised evaluation used average pooling of embeddings for 1000 patches per slide or case with bootstrapping over test set slides. For tasks with more than two classes, AUCs for computing the linear probe metric were calculated using macro-averaging. Linear classifiers were trained using Scikit-Learn's LogisticRegression implementation, with L2 regularization (inverse coefficient selected via 5-fold cross validation from a grid of 10 log-spaced values ranging from 1e-4 to e4), using the L-BFGS optimizer trained for 100 updates. Analyses were performed using Python, Numpy, and scikit-learm libraries.

### Results

Patch-level linear probing—Baseline models as well as SimCLR-best and MSN-best (combining individual optimizations) were evaluated on the test sets for all linear probe tasks. See Table 9 for linear probe metric performance for all models tested.

TABLE 9
Performance evaluation for patch-level linear probe tasks

| | | Linear Probe |
|---|---|---|
| Method | Architecture | Metric [95% CI] |
| Supervised | Vit-S/16 | 87.79 [87.06-88.49] |
| (ImageNet-21k) | | |
| CTransPath | Conv + | 92.09 [91.45-92.62] |
| | SwinTransformer | |
| Lunit DINO | Vit-S/16 | 92.00 [91.34-92.53] |
| Lunit DINO | Vit-S/8 | 92.26 [91.65-92.70] |
| SimCLR baseline | Vit-S/16 | 92.69 [92.08-93.18] |
| MSN baseline | Vit-S/16 | 92.80 [92.19-93.27] |
| SimCLR-best | Vit-S/16 | 93.20 [92.71-93.72] |
| MSN-best | Vit-S/16 | 93.43 [92.88-93.84] |
| SimCLR-best | Vit-B/16 | 93.08 [92.44-93.57] |
| MSN-best | Vit-B/16 | 93.74 [93.16-94.15] |

Average AUC across tasks for base and optimized models (test set). Confidence intervals were generated via bootstrap resampling over test set slides with 1000 replicates.

For the optimized models, average AUC was 93.20% [95% CI 92.71%-93.72%] for SimCLR-best and 93.43% [95% CI 92.88%-93.84] for MSN-best. The SSL baseline models demonstrated average AUCs of 92.69% [95% CI 92.08%-93.18%] for SimCLR-base and 92.80% [95% CI 92.19%-93.27%] for MSN-base. Recently described approaches from Kang et al. (DINO ViT) and Wang et al. (CTransPath) were also implemented and demonstrated an average AUC of 92.00% [95% CI 91.34%-92.53%](ViT-S/16) and 92.09% [95% CI 91.45%-92.62%], respectively.

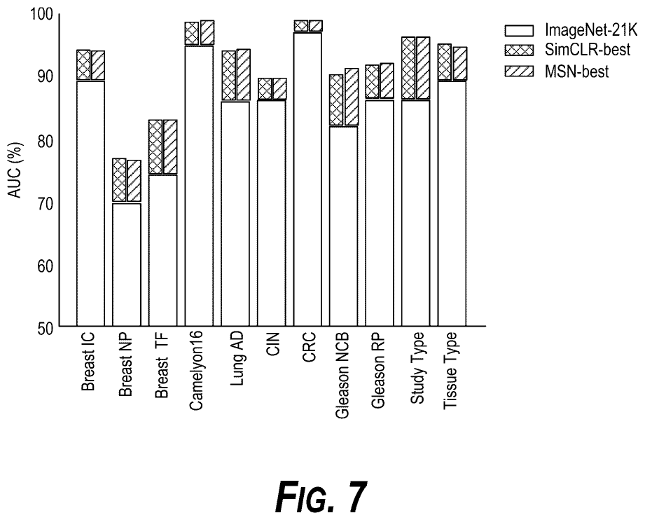

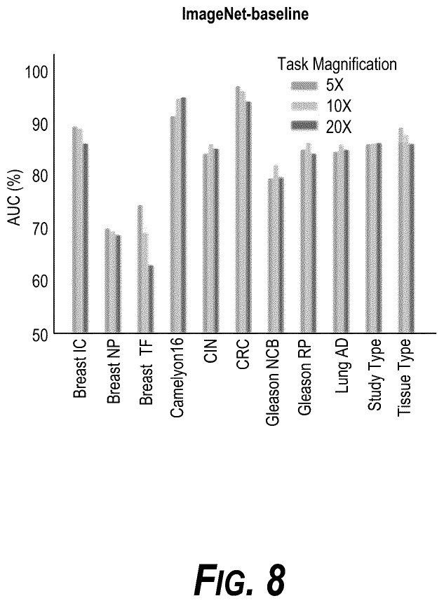

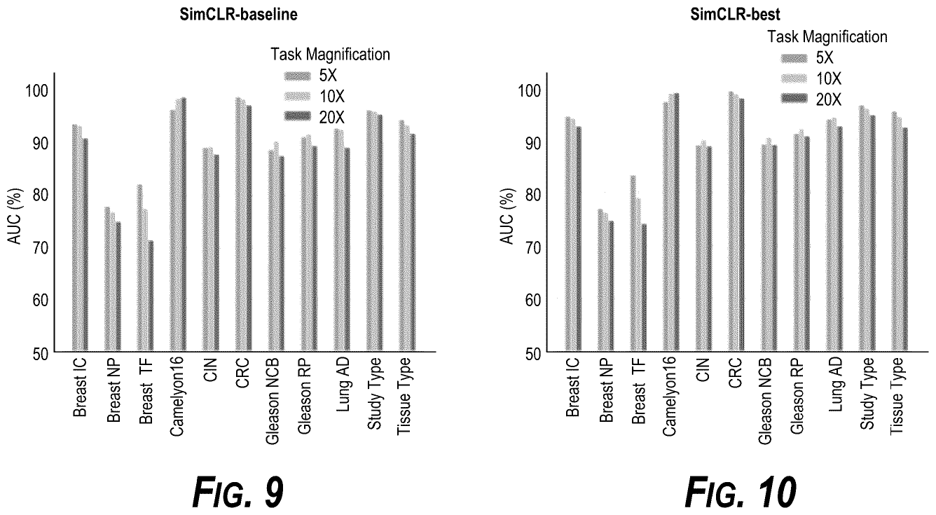

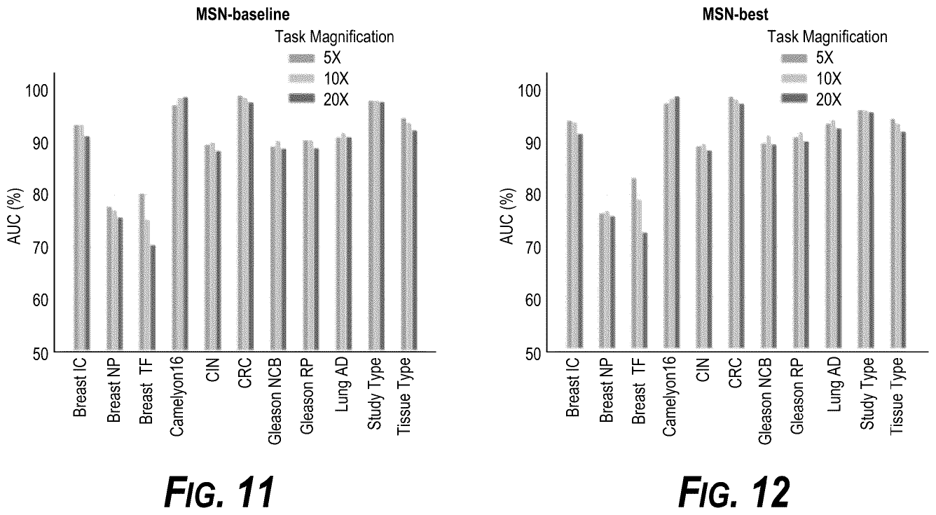

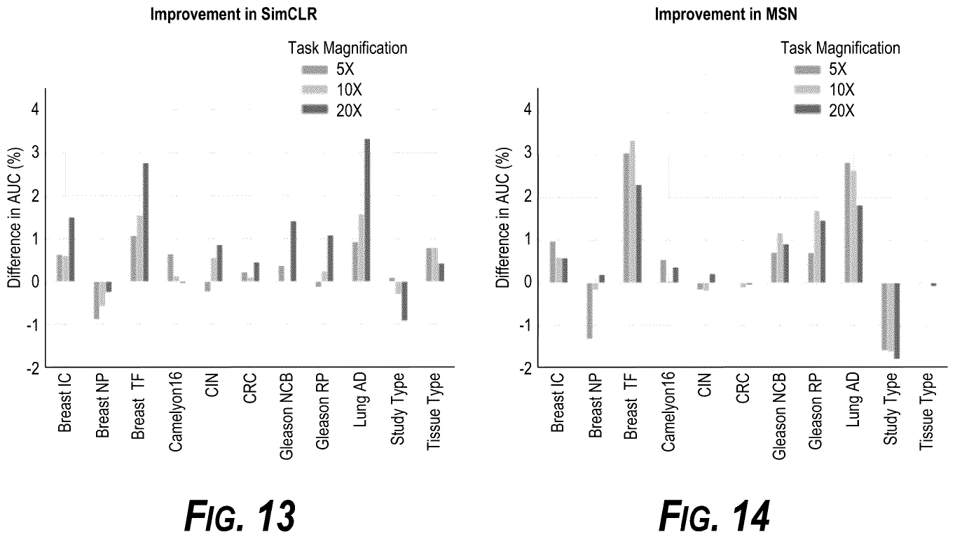

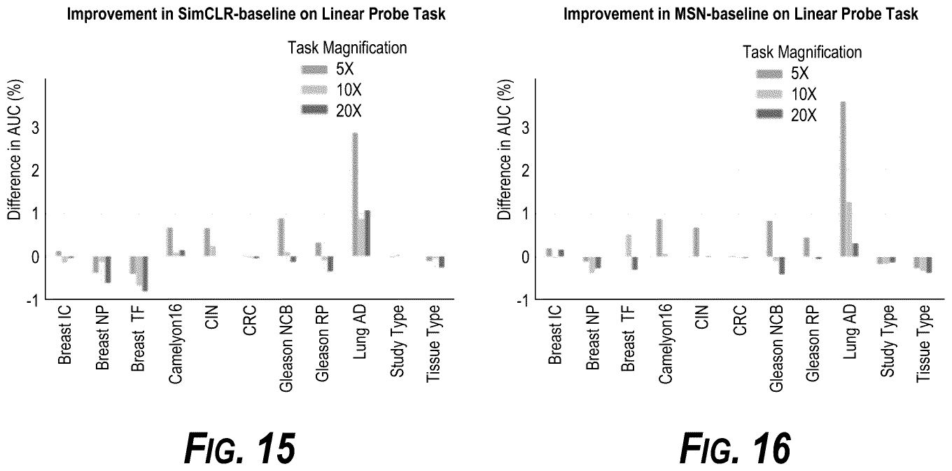

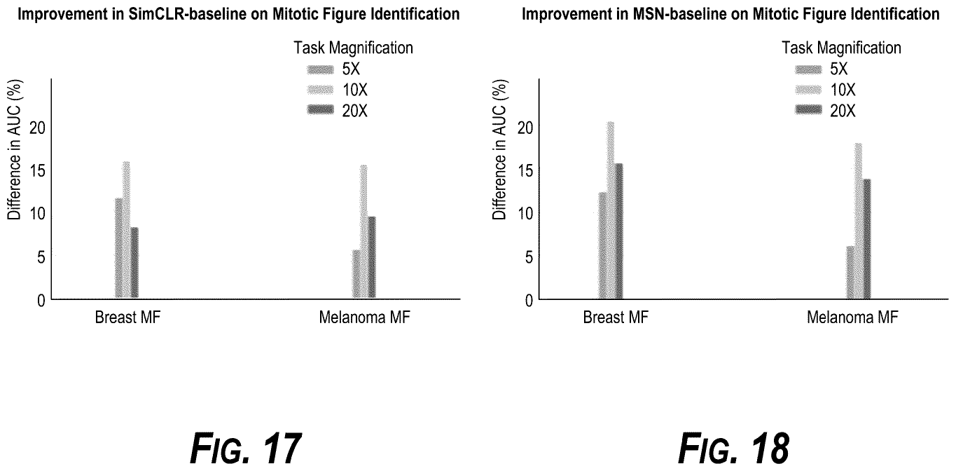

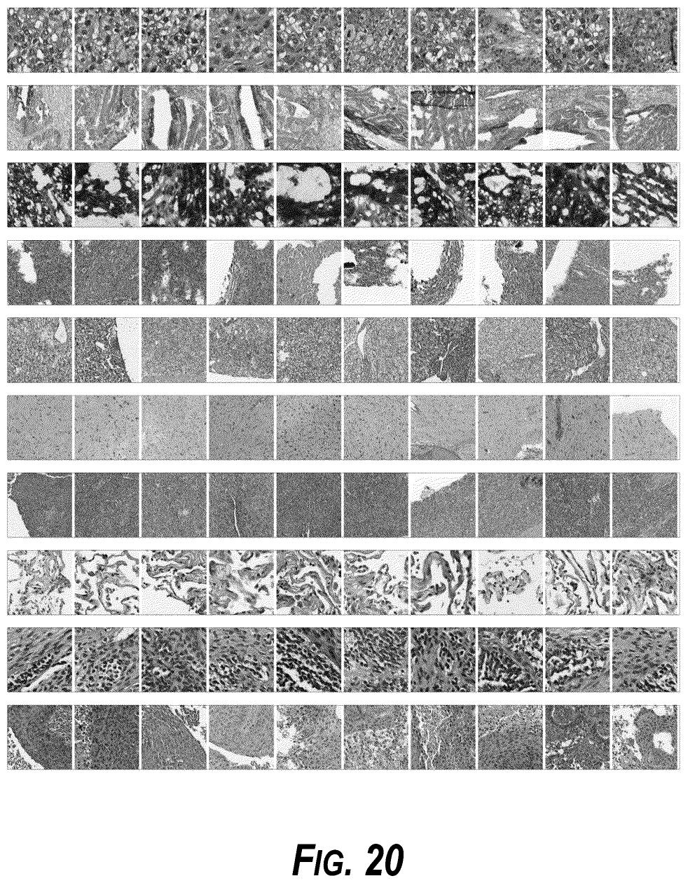

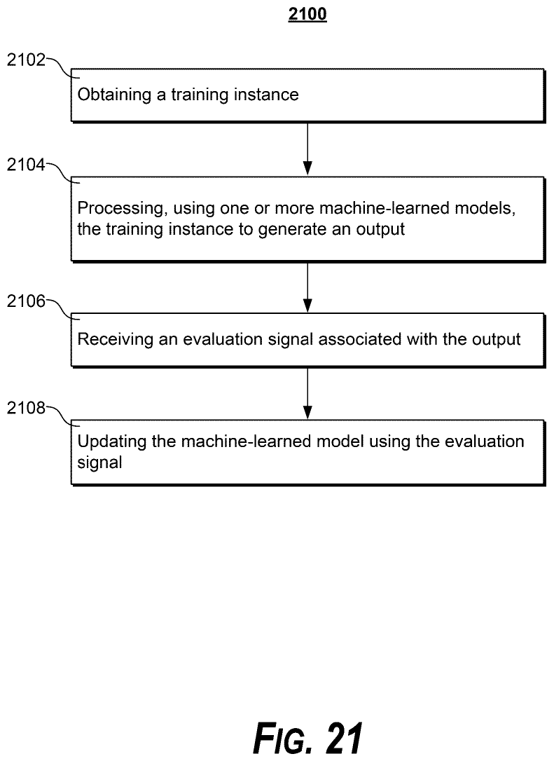

The “best” SSL models showed substantial increases in patch-level linear evaluation performance for all tasks over the supervised ImageNet baseline (FIG. 7). Performance across all individual tasks, models, and magnifications is further summarized in FIGS. 8 to 18. Generally the largest performance increases for SSL models were seen for tasks with relatively lower supervised ImageNet baseline performance, such as breast cancer nuclear pleomorphism, breast cancer tubule formation, lung adenocarcinoma histologic subtyping, and prostate cancer biopsy Gleason grading.

We also conducted ablation experiments in which we removed individual variations from the best performing models. For SimCLR-best, this meant removing either RandStainNA or the 512 patch size variant. For MSN-best, this meant removing RandStainNA, the SimCLR hybrid loss, or the Poisson noise component of PathBlur.

See Table 10.

TABLE 10
Ablation of individual variants from SimCLR-best and MSN-best

| | | Patch | Hybrid | PathBlur | Linear |
|---|---|---|---|---|---|
| SSL | | Size | loss (0.5 | (Poisson | Probe |
| Method | RandStainNA | 512 | weight) | only) | AUC |
| SimCLR | ✓ | ✓ | NA | NA | 93.20% |
| | X | ✓ | NA | NA | 92.92% |
| | ✓ | X | NA | NA | 92.83% |
| MSN | ✓ | NA | ✓ | ✓ | 93.43% |
| | ✓ | NA | ✓ | X | 93.40% |
| | ✓ | NA | X | ✓ | 93.51% |
| | X | NA | ✓ | ✓ | 93.29% |

Test set linear probe performance for optimized SimCLR-best and MSN-best models with ablation of individual components as indicated. Top rows of each SSL method, represent the SimCLR-best and MSN-best models, respectively. For PathBlur, only Poisson noise was used in the MSN-best ablation experiments based on its superior performance on the linear probe metric for the tune set when compared to Poisson noise plus JPEG artifacts.

The one variation that consistently resulted in decreased test set performance when removed individually was RandStainNA (with default color perturbations still used), supporting the persistent value of this augmentation during training. Other variations improved performance in combination on the tune set.

### Mitotic Figure Identification and Center Embeddings

To evaluate use of SSL embeddings for a “held out” patch-level task (ie. independent from the linear probe tasks), we performed linear evaluation for mitotic figure detection in two cancer types: breast cancer and melanoma. This task requires high-magnification input patches and has the property that the patch-level labels only apply to a small center region of the input patch. For this task, we used “center embeddings”, which demonstrated substantial improvements over use of the “class token embeddings” alone (see “Center Embeddings” section of Methods). With the MSN-best model, the use of center-embeddings achieved an average AUC of 97.80% on the linear probe metric versus 89.06% without center embeddings (Table 11). For SimCLR-best, the improvement was even larger, from an average AUC of 79.32% without center embeddings to 95.21% with center embeddings.

TABLE 11
Performance for mitotic figure identification

Average AUC for mitotic figure
identification

| | w/o center | w/center |
|---|---|---|
| Model | embeddings | embeddings |
| Supervised | 73.77% | 81.74% |
| (ImageNet-21k) | | |
| SimCLR-base | 87.82% | 96.64% |
| MSN-base | 82.63% | 97.27% |
| SimCLR-best | 79.32% | 95.21% |
| MSN-best | 89.06% | 97.80% |

Breast cancer and melanoma mitotic figure identification were evaluated separately using their respective test sets and the two resulting AUCs were averaged. Metrics represent evaluation at 20× (˜0.5 microns/pixel), which was the best performing magnification (of the three magnifications tested) for all mitotic figure models.

Of note, the SimCLR-base model outperformed the SimCLR-best model at the mitotic figure identification task, perhaps consistent with the fact that this task was not used during model optimization and selection of “best” configurations. As such, we also evaluated the impact of individual training variations on this task specifically. Interestingly a few variations showed more of a benefit for linear evaluation of mitotic figure identification than for the overall linear probe metric. For MSN, PathBlur improved the performance over the MSN-baseline configuration substantially, increasing the mitotic figure average AUC by 3.41% (from 81.73% to 85.14%). For SimCLR, both PathBlur and hard negative mining modestly improved the mitotic figure average AUC over the SimCLR-baseline configuration. For PathBlur the increase was 0.63% (from 87.15% to 87.78%) and for hard negative mining the increase was 0.67% (from 87.15 to 87.82%).

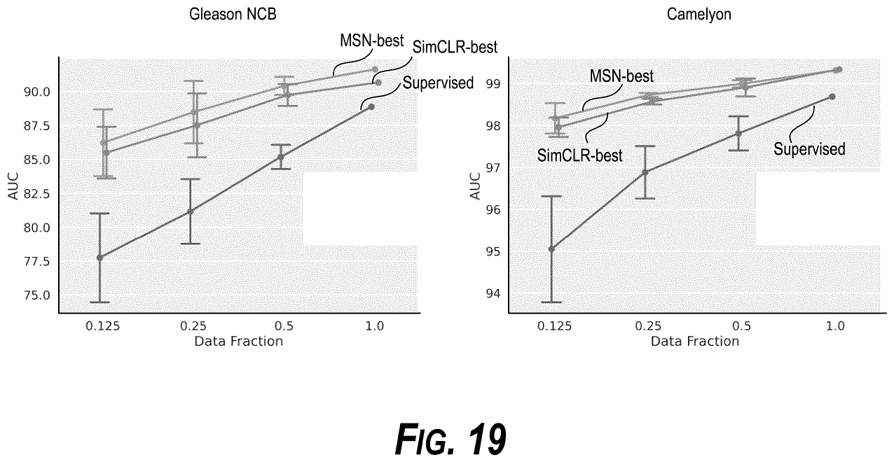

We also evaluated the use of center embeddings on the 11 linear probe metric tasks and found that center embeddings increased performance modestly overall, with the largest improvement for lung cancer histologic subtyping (as summarized in Table 12 and FIGS. 15 to 18).

TABLE 12
Test set evaluation of linear probe metric using center embeddings

| | | Linear Probe | Linear Probe |
|---|---|---|---|
| | | Avg AUC | Avg AUC |
| | | (w/center | (w/o center |
| Method | Architecture | embeddings) | embeddings) |
| ImageNet 21-k | Vit-S/16 | 87.64% | 87.79% |
| SimCLR-base | Vit-S/16 | 93.12% | 92.69% |
| MSN-base | Vit-S/16 | 93.14% | 92.80% |
| SimCLR-best | Vit-S/16 | 93.51% | 93.20% |
| MSN-best | Vit-S/16 | 93.51% | 93.43% |

The average of the center 2×2 patch token embeddings appended to the class embedding was used for linear evaluation.

Lastly, to demonstrate that it was indeed the center embeddings that improved performance, we explored the use of increasing center N×N token embeddings (up to the complete set of 14×14 tokens per patch or using the 2×2 center embeddings alone; Table 13).

TABLE 13
Linear probe metric with center embeddings usage

| Center | Linear | Mitotic |
|---|---|---|
| embeddings usage | probe Avg AUC | figure AUC |
| Baseline (no usage) | 92.83% | 82.63% |
| 2 × 2 | 93.24% | 97.27% |
| 4 × 4 | 93.24% | 96.87% |
| 6 × 6 | 93.18% | 93.10% |
| 8 × 8 | 93.08% | 89.60% |
| 10 × 10 | 93.00% | 86.73% |
| 12 × 12 | 92.95% | 84.73% |
| 14 × 14 (all | 92.91% | 85.07% |
| patch tokens) | | |
| 2 × 2 only | 90.70% | 97.09% |
| (no CLS emb.) | | |

Results for variations in size of the region used for center embeddings, as evaluated on the tune split data. Except as specified in the last row, the CLS token embedding was concatenated to the center patch token embeddings.

### Weakly Supervised Linear Evaluation

To better understand utilization and generalization of the patch-level embeddings for slide-level or case-level tasks, we evaluated performance for several types of such weakly supervised tasks including gene expression, survival prediction, ER status, EGFR mutation status, MSI status, and TCGA study type. Linear evaluation results for these tasks (using average pooling of patch embeddings across 1000 patches per slide/case) are summarized in Tables 14 and 15, demonstrating substantially better performance using pathology-specific SSL models as compared to ImageNet pre-training alone.

TABLE 14
Weakly supervised task performance with linear evaluation

| | Weakly-supervised Task (train/tune/test case count) | | | | | |
|---|---|---|---|---|---|---|
| | TCGA | Survival | | | | |
| | Study | TCGA | | ER status | EGFR | MSI Status |
| | Type | pancancer | BRCA set 1 | (BRCA) | (LUAD) | (COAD) |
| | (2314/1167/ | (785/379/ | (525/267/ | (489/256/ | (230/120/ | (198/101/ |
| Method | 1165) | 359) | 260) | 238) | 119) | 104) |
| Supervised | 98.8% | 63.8% | 73.8% | 86.6% | 63.9% | 86.7% |
| (ImageNet-21k) | | | | | | |
| SimCLR | 99.6% | 64.6% | 77.3% | 89.7% | 67.1% | 93.0% |
| baseline | | | | | | |
| MSN baseline | 99.7% | 64.1% | 77.2% | 90.8% | 72.7% | 93.3% |
| SimCLR-best | 99.7% | 65.6% | 77.9% | 91.2% | 68.6% | 93.1% |
| MSN-best | 99.6% | 67.7% | 78.4% | 91.3% | 69.4% | 94.3% |
| CTransPath | 99.4% | 66.2% | 75.8% | 90.4% | 73.0% | 91.7% |
| Lunit DINO Vit- | 99.4% | 67.1% | 76.8% | 90.8% | 70.6% | 90.9% |
| S/16 | | | | | | |
| Lunit DINO Vit- | 99.6% | 67.7% | 77.4% | 90.9% | 70.0% | 89.7% |
| S/8 | | | | | | |

Linear evaluation of weakly supervised tasks using average pooling of embeddings from 1000 patches per slide. Number of slides used for training and testing the linear model for each task are provided as indicated. Values represent AUC for slide-level classification as defined for each task in the methods. Bold indicates the best model for a given task. Abbreviations: BRCA: breast cancer; ER; Estrogen Receptor; EGFR: Epidermal growth factor receptor; MSL: Microsatellite instability; LUAD: Lung Adenocarcinoma. BRCA set 1 is composed of 25 genes based on the top image-based gene expression predictions from Wang et al., see Table 15.

TABLE 15
Extended weakly supervised evaluation

| | | | | | | MSI | |
|---|---|---|---|---|---|---|---|
| | | | | | | Status | |
| | | | | | | (MSI-H | TCGA Study |
| | | BRCA- | BRCA- | LIHC- | LIHC- | or L) | Type (31 |
| | BRCA set 2 | oncotype | PAM50 | set 1 | set 2 | (COAD) | studies) |
| | (525/267/ | (525/267/ | (525/267/ | (180/88/ | (180/88/ | (198/101/ | (4642/2326/ |
| Method | 260) | 260) | 260) | 90) | 90) | 104) | 2329) |
| Supervised | 73.5% | 67.1% | 69.7% | 67.3% | 65.5% | 77.7% | 98.5% |
| (ImageNet-21k) | | | | | | | |
| SimCLR | 77.1% | 69.7% | 73.3% | 71.4% | 67.4% | 78.4% | 99.5% |
| baseline | | | | | | | |
| MSN baseline | 76.8% | 70.2% | 73.0% | 68.9% | 69.6% | 79.9% | 99.5% |
| SimCLR-best | 78.1% | 70.0% | 74.3% | 72.1% | 67.7% | 79.5% | 99.3% |
| MSN-best | 78.2% | 70.7% | 74.6% | 72.6% | 67.6% | 81.4% | 99.5% |
| CTransPath | 76.0% | 69.4% | 72.6% | 71.3% | 66.8% | 81.7% | 99.0% |
| Lunit DINO | 76.5% | 69.3% | 73.0% | 73.9% | 67.2% | 79.4% | 99.2% |
| Vit-S/16 | | | | | | | |
| Lunit DINO | 76.8% | 70.1% | 73.4% | 73.0% | 67.3% | 79.4% | 99.4% |
| Vit-S/8 | | | | | | | |

In Table 15, results represent linear evaluation using average pooling of embeddings from 1000 patches per slide. For gene expression tasks, values are AUC for case-level classification per gene, averaged across the genes in each gene set, as defined in the methods. For MSI, these data represent classification of MSI-H or MSI-L versus MSS (as opposed to MSI-H versus other). For study type, one study of the 32 TCGA solid tumor studies was dropped due to too few cases (DBLC). Bold indicates the highest AUC for a given task. Abbreviations: BRCA: breast cancer; LIHiC; Liver hepatocellular cancer; MSI: microsatellite instability; COAD: colorectal adenocarcinoma. Oncotype and PAM-50 are well established gene sets in breast cancer classification and prognosis. BRCA-set 2, LIHC-set 1, and LIHC-set 2 gene sets are based on top predicted genes from prior work.

### Fine-Tuning Data Efficiency

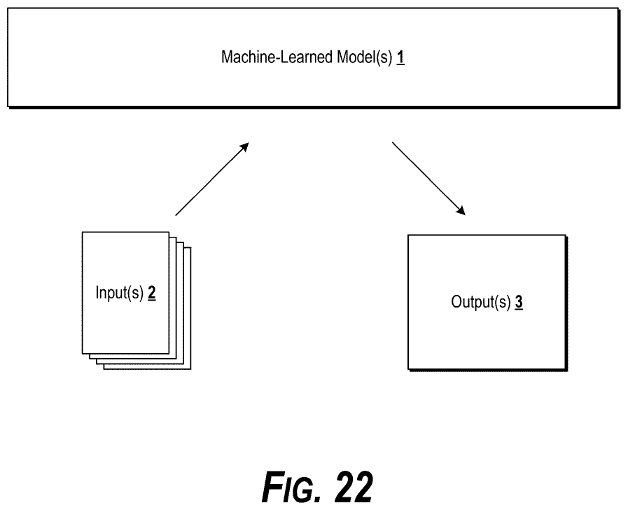

One value propositions for pathology-specific embedding models is the ability to reduce the necessary volume of data for training performant models across multiple applications. As such, we explored data efficiency of fine tuning a representative SSL model (MSN-best) for two well established benchmark tasks: Gleason grading in prostate biopsies (Gleason NCB), and metastatic breast cancer detection in lymph nodes (CAMELYON16). We evaluated the impact of training data volume by simulating different amounts of slides available for training (using a fixed number of 5M labeled patches while titrating the number of slides). These results are summarized in FIG. 19.

In FIG. 19, training for all WSI data fractions used the same number of labeled patches but a different number of WSIs (as described in the Methods). Error bars are standard deviations of five different models, each trained on a different subsample of the available WSIs for the corresponding data titration point. Supervised refers to the ImageNet-21k pretraining (ViT-S/16 architecture) and MSN-best and SimCLR-best represent the pathology domain self-supervised models. Fine-tuning pathology-specific SSL models (MSN-best and SimCLR-best) provided a substantial benefit over fine-tuning a model pre-trained on ImageNet across all data volumes, with the larger improvements at lower data volumes. For both tasks, fine-tuning the MSN-best model using roughly a quarter of available slides was comparable to fine-tuning a model pre-trained on ImageNet using all available slides. Additionally, the SSL pretraining outperformed ImageNet pretraining when fine-tuning on all available slides.

### Discussion of Measured Results

The resulting models achieve performant results across a diverse set of benchmark tasks. One component of this work was the use of a variety of tasks with rigorously established datasets and annotations for SSL model optimization as well as evaluation. For patch-level tasks, this included 17 different tissue types, 12 different cancer types, and several different types of tasks such as tumor identification, grading, subtyping, and classification. These tasks involved high quality patch labels, established in most cases via annotation by multiple subspecialist pathologists and use of majority vote (rather than a single pathologist annotation). We also demonstrate generalizability and value of domain-specific embeddings on weakly supervised tasks. Furthermore, we found that the resulting embeddings can be used in a data efficient manner to provide superior results using far less data than with ImageNet pre-training and supervised fine-tuning.

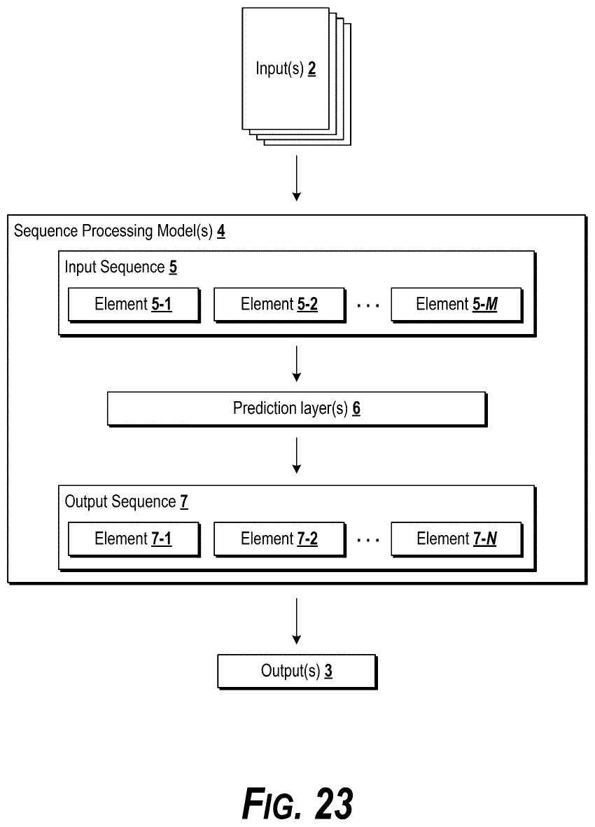

The weakly supervised results observed in this study not only demonstrate generalizable value of the embeddings to challenging tasks for which models weren't specifically optimized, but also suggest the features extracted by the pathology-specific SSL model could enable scalable biomarker discovery efforts. In other words, the ability of embeddings from a single embedding model to demonstrate predictive value for multiple biomarker tasks across cancer types, including gene expression, prognosis, and tumor grading, suggests that the models have learned biologically meaningful histomorphological features. Such embeddings and the evaluation of associated image regions (as shown in FIG. 20) can enable identification of novel biomarkers and biological insights.

To produce FIG. 20, patches (n=60 million) were clustered by k-means clustering (k=18,000) based on their embedding vectors (using the SimCLR-best model in this example). Random patches from a random subset of clusters (n=10) are shown here (one cluster per row) to provide visual examples. These examples illustrate that embedding vectors represent visually distinct features with high potential for downstream applications such as classification, feature evaluation, and similarity-based retrieval.

The exploration of dataset size represents another aspect of this work, with preliminary experiments utilizing up to 600 million patches from the TCGA dataset.

Our exploration of center embeddings also offers interesting insights for downstream applications. A common approach for applying pathology ML models is patch classification where WSIs are broken down into hundreds of thousands of smaller patches, on the order of 32×32 pixels, that are each assigned a label from either annotations or model inference. For each of these labeled patches, a larger, surrounding input patch with useful contextual information represents the image that is actually fed into the ML model. Our example experiment linear probing tasks all relate to this application, whereby labels correspond to the center patch within an input image patch. In our work we have shown that in high magnification tasks, the embeddings of center patch tokens can be particularly informative. As the label may not always correspond to the “center patch”, we contemplate further leveraging of information within individual patch tokens embeddings for more efficient and accurate patch classification.

We also propose using models that utilize lower resolution/magnification input images, such that useful embeddings can be generated without requiring the potentially expensive inference for thousands of embeddings per whole slide image. Embeddings from large models and high resolution patches can provide high quality information, but may be expensive to generate and store. Additionally, while patch aggregation by average pooling was used in the example experiments to demonstrate the quality of the embedding model in isolation from variations in slide-level, non-linear models, other strategies to combine patch-level embeddings across a slide can be used. This could involve attention based MIL (ABMIL) approaches, aspects of hierarchical information, embedding-based clustering and quantification as input features, transformer based aggregation layers, or other ways of combining information from embeddings across patches and magnifications. Priors such as tumor masks can be used from existing models and to consider clinically meaningful thresholds and metrics for specific biomarker tasks. Expanding on the number of tissue types evaluated in downstream applications will also be valuable for understanding the generalizability and capability of such models. While the example experiments focused on both cancer and non-cancer specimens, additional tissue types and disease entities could also be added. We also propose multimodal processing models that analyze histopathology image data and natural language data or other biomedical sensor data.

As described for weakly supervised tasks, results represent linear evaluation using average pooling of embeddings from 1000 patches per slide. For gene expression tasks, values are AUC for case-level classification per gene, averaged across the genes in each gene set, as defined in the methods. For MSI, these data represent classification of MSI-H or MSI-L versus MSS (as opposed to MSI-H versus other as calculated for Table 5 of the main text). For study type, one study of the 32 TCGA solid tumor studies was dropped due to too few cases (DBLC). Bold indicates the highest AUC for a given task. Abbreviations: BRCA: breast cancer; LIHC; Liver hepatocellular cancer; MSI: microsattelite instability; COAD: colorectal adenocarcinoma. Oncotype and PAM-50 are well established gene sets in breast cancer classification and prognosis. BRCA-set 2, LIHC-set 1, and LIHC-set 2 gene sets are based on top predicted genes from prior work, see description above for genes and references.

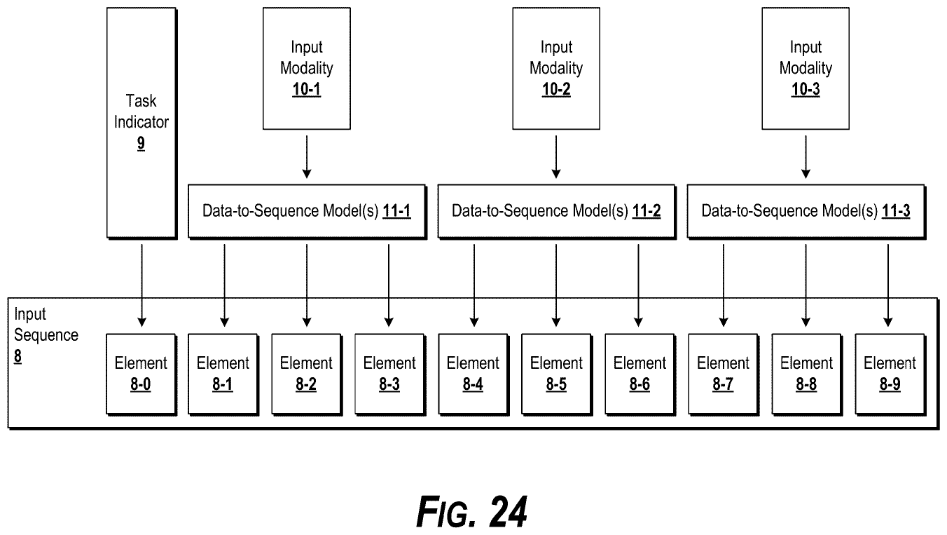

FIG. 21 depicts a flowchart of a method 2100 for training one or more machine-learned models according to aspects of the present disclosure. For instance, an example machine-learned model can include an image processing model for processing histopathology images as described herein.

One or more portion(s) of example method 2100 can be implemented by a computing system that includes one or more computing devices such as, for example, computing systems described with reference to the other figures. Each respective portion of example method 2100 can be performed by any (or any combination) of one or more computing devices. Moreover, one or more portion(s) of example method 2100 can be implemented on the hardware components of the device(s) described herein, for example, to train one or more systems or models. FIG. 21 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 21 is described with reference to elements/terms described with respect to other systems and figures for exemplary illustrated purposes and is not meant to be limiting. One or more portions of example method 2100 can be performed additionally, or alternatively, by other systems.

At 2102, example method 2100 can include obtaining a training instance. A set of training data can include a plurality of training instances divided between multiple datasets (e.g., a training dataset, a validation dataset, or testing dataset). A training instance can be labeled or unlabeled. Although referred to in example method 2100 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 2104, example method 2100 can include processing, using one or more machine-learned models, the training instance to generate an output. The output can be directly obtained from the one or more machine-learned models or can be a downstream result of a chain of processing operations that includes an output of the one or more machine-learned models.

At 2106, example method 2100 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 2108, example method 2100 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 2100 can include implementing a number of generalization techniques (e.g., weight decays, dropouts, etc.) to improve the generalization capability of the models being trained.

In some implementations, example method 2100 can be implemented for training a machine-learned model from an initialized state to a fully trained state (e.g., when the model exhibits a desired performance profile, such as based on accuracy, precision, recall, etc.).

In some implementations, example method 2100 can be implemented for particular stages of a training procedure. For instance, in some implementations, example method 2100 can be implemented for pre-training a machine-learned model. Pre-training can include, for instance, large-scale training over potentially noisy data to achieve a broad base of performance levels across a variety of tasks/data types. In some implementations, example method 2100 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

FIG. 22 is a block diagram of an example processing flow for using machine-learned model(s) 1 to process input(s) 2 to generate output(s) 3. Various features described herein with respect to machine-learned model 1 (e.g., in the context of FIGS. 21 to 30) are to be understood as also describing various example attributes of implementations of machine-learned model 102, as machine-learned model 102 can be implemented using various configurations of machine-learned model 1.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

FIG. 23 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf Image-based input source(s) can be tokenized by extracting and serializing patches from an image.

In general, arbitrary data types can be serialized and processed into input sequence 5. It is to be understood that element(s) 5-1, 5-2, . . . , 5-M can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

FIG. 24 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

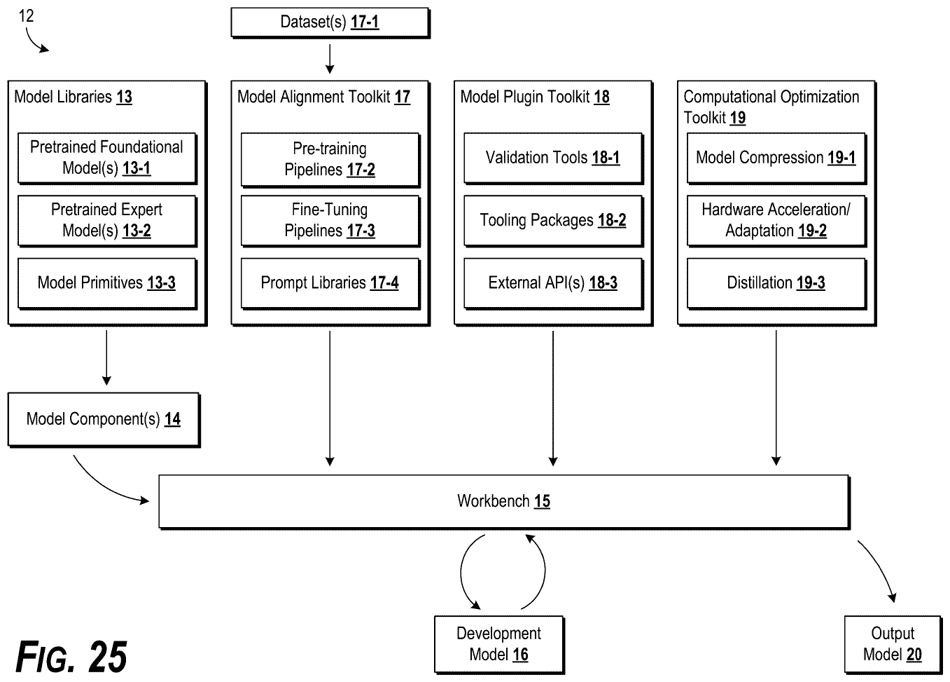

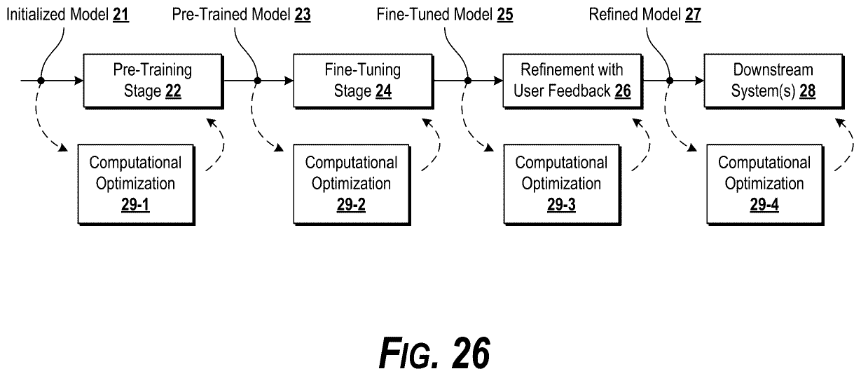

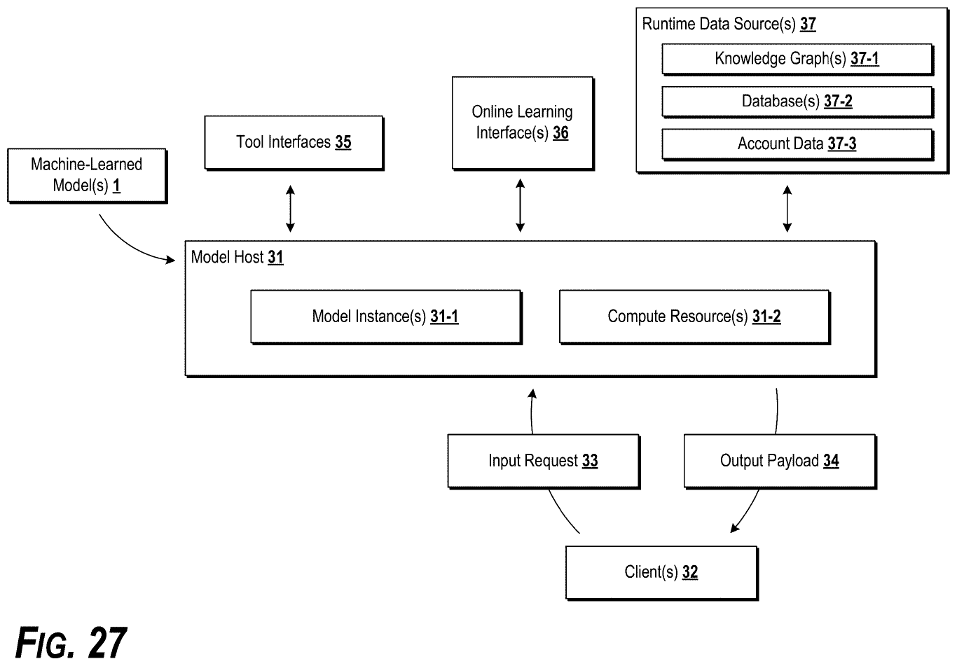

FIG. 25 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1000 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

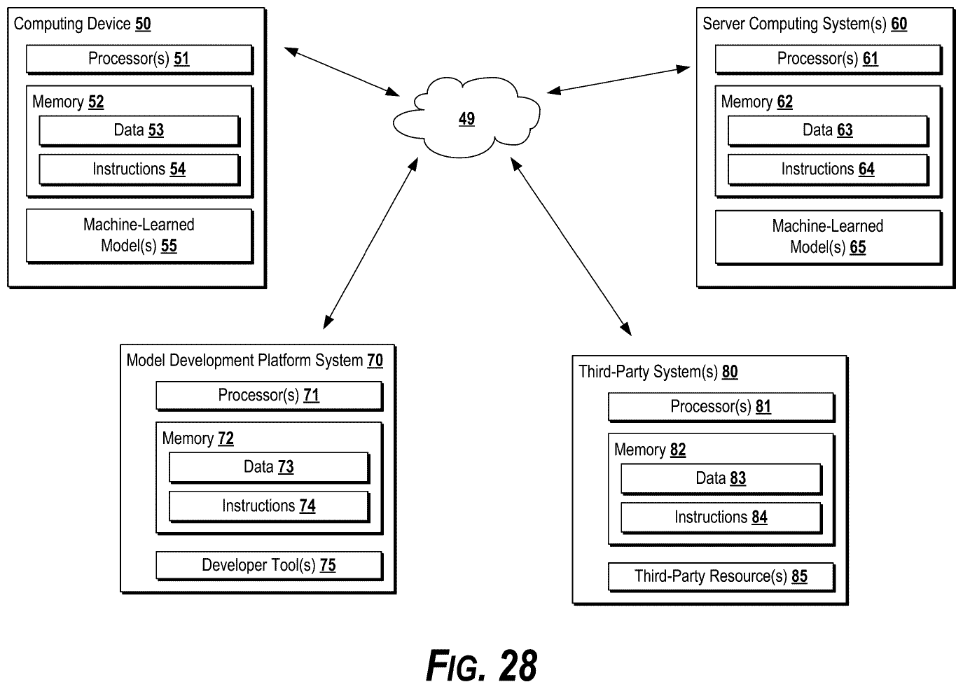

FIG. 26 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 26 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 26 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

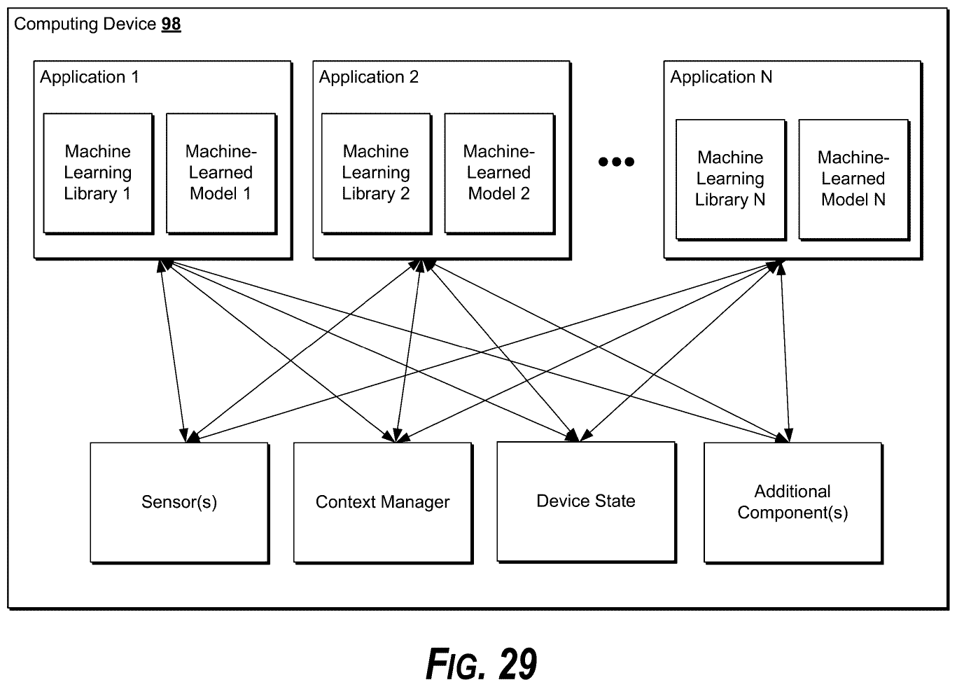

FIG. 27 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

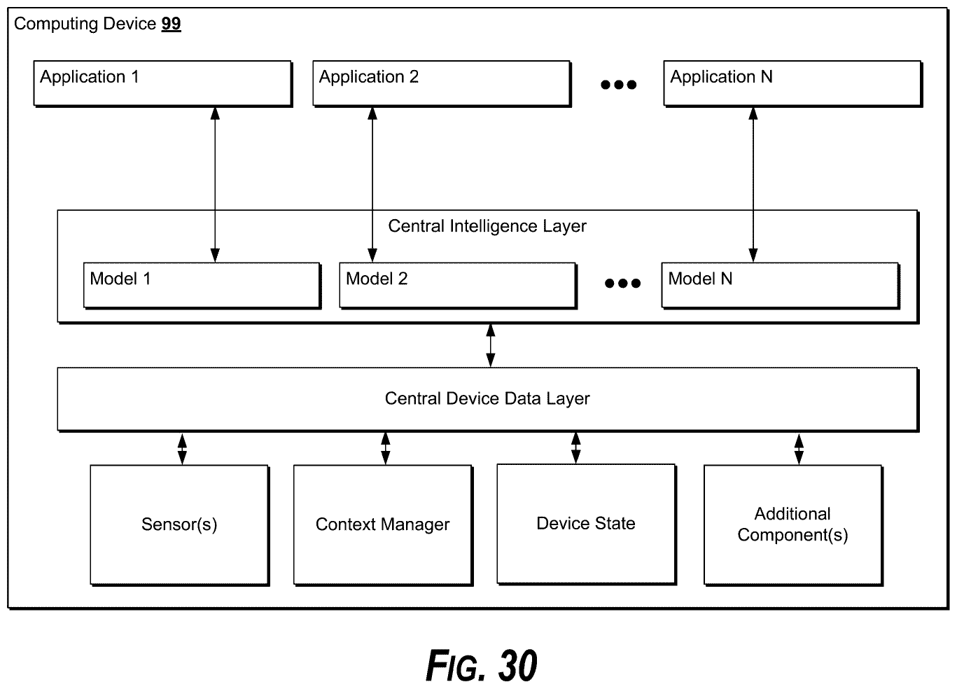

FIG. 28 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 28 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 28 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

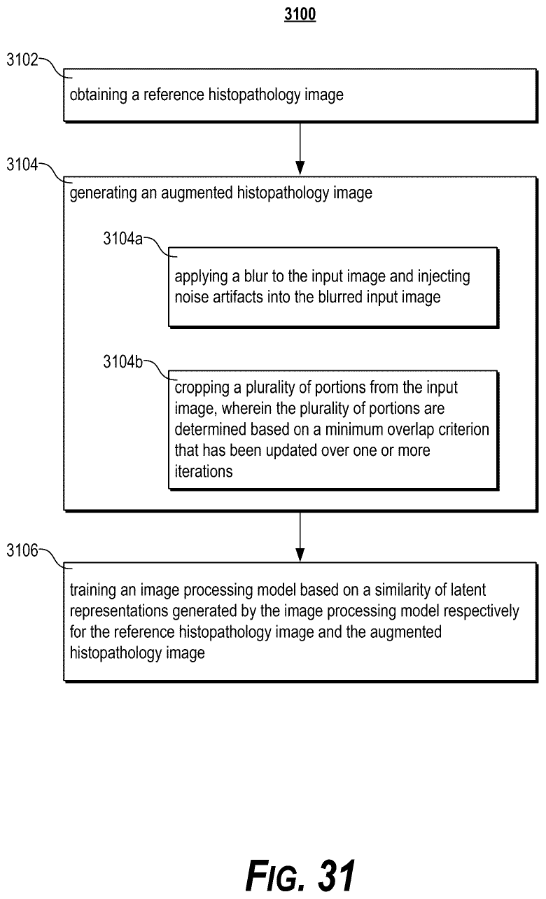

FIG. 29 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 29, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 30 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 30, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 30, the central device data layer can communicate with a number of other components of the computing device, such as, for example, one or more sensors, a context manager, a device state component, or additional components. In some implementations, the central device data layer can communicate with each device component using an API (e.g., a private API).

Computing device 50, 98, 99 can be, include, or operate cooperatively with one or more imaging devices to provide augmented or assisted imaging functionality using an image processing model trained or otherwise configured according to the present disclosure. For example, an imaging device can include a device configured to provide digital or optical magnification to capture and process image data of objects with a reproduction ratio of greater than about 0.1, such as greater than about 0.5, such as greater than about 1, such as greater than about 2, such as greater than about 5, such as greater than about 10, such as greater than about 20, such as greater than about 40, such as greater than about 80, etc. An optical reproduction ratio can include, for instance, a ratio between a size of the object as projected onto an imaging sensor (e.g., projected using one or more optical elements, such as lenses) and an actual size of an object.

Images captured by an imaging sensor can be processed using an image processing model according to the present disclosure to perform various tasks. For instance, the tasks can include diagnostic tasks (e.g., predicting diagnostic conditions associated with a perceived object, etc.), salience mapping (e.g., highlighting or otherwise emphasizing areas of an image most associated with diagnostic decision making, etc.), image resizing, clarifying, etc. For example, computing device 50, 98, 99 can be, include, or operate cooperatively with one or more imaging devices to provide augmented reality (AR) user interfaces that overlay a base image from the imaging device with information obtained using an image processing model according to the present disclosure.

In an example, computing device 50, 98, 99 generates data representing an enhancement to the view of the sample as seen by a user, which is generated and projected by an AR display unit and combined with an eyepiece field of view (e.g., using a semitransparent mirror, by compositing two digital display streams, etc.).

Streaming of captured images by an image sensor into an image processing model can performing inference on the images can provide enhancements to the imaging capability of the tool and assist a pathologist in characterizing or classifying a specimen in substantial real time as the operator navigates around the slide (e.g., by use of a motor driving a stage), by changing magnification by switching to a different objective lens, or by changing depth of focus by operating a focus knob.

An example method is disclosed of assisting a user (e.g., pathologist) in review of a slide containing a biological sample with a microscope. The example method includes a step of capturing with a camera a digital image of the sample as seen by the user through a viewport (e.g., eyepiece, digital display, etc.). The example method can include using an image processing model of according to the present disclosure to identify areas of interest in the sample from the image captured by the camera. The example method can include superimposing an enhancement to the view of the sample as seen by the user. As the user moves the sample relative to the microscope optics or changes magnification or focus of the microscope, a new image can be captured by the camera and supplied to the image processing model, and a new enhancement can be overlaid onto the new view of the sample. The overlaid enhancement can assist the user in classifying the biological sample.

An example enhancement can be in the form of a “heat map” superimposed on the field of view registered over which cells in the sample are likely to be cancerous (or satisfy any other diagnostic outcome). The “heat map” can be a set of pixels representing tissue likely to be cancerous (or satisfy any other diagnostic outcome) which are colored in accordance with a coding scheme to highlight areas (e.g. in red) which have a high probability of containing cancerous cells (or cells that satisfy any other diagnostic outcome). The superimposing of the heat map can assist the pathologist in characterizing the sample because it can direct attention to areas of interest that are particularly likely to be cancerous. If the pathologist were to change microscope objective lenses in order to zoom in on the heat map area, for example (e.g., change to a 40× lens), a new field of view of the sample could be seen through the microscope eyepiece and directed to the camera. The camera can then capture a new image, and a new heat map can be generated and overlaid on the field of view to further aid the pathologist's investigation of the sample at the higher magnification. Of particular advantage, image processing models according to the present disclosure can be trained across multiple different magnification levels to enable robust operation over multiple magnification levels.

An example enhancement can be in the form of an outline superimposed on a region of a field of view circumscribing cells in the sample which are likely to be cancerous (or satisfy any other diagnostic outcome). An example enhancement includes a text box providing annotations, such as, in an example, Gleason score grading and size measurements.

Another example enhancement can be a confidence score that the cells of the sample are cancerous (or satisfy any other diagnostic outcome). For example, the enhancement could take the form of a probability or confidence score, such as 85% confidence that the cells in the outline are Gleason Grade 3, and 15% confidence that the cells in the outline are Gleason Grade 4. Additionally, the measurement (0.12 μm) could be the diameter of the whole outlined region.

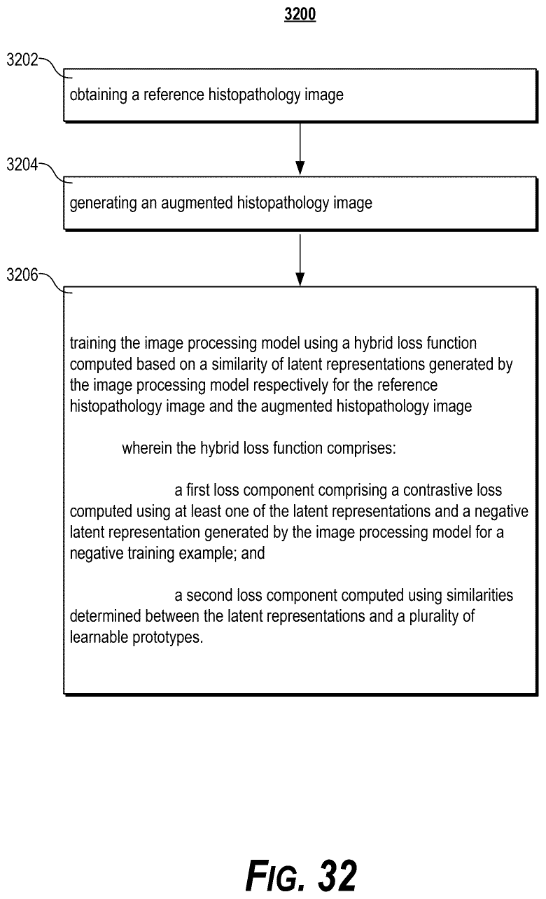

FIG. 31 depicts a flowchart of a method 3100 according to aspects of the present disclosure. For instance, an example machine-learned model can include an image processing model for processing histopathology images as described herein.

One or more portion(s) of example method 3100 can be implemented by a computing system that includes one or more computing devices such as, for example, computing systems described with reference to the other figures. Each respective portion of example method 3100 can be performed by any (or any combination) of one or more computing devices. Moreover, one or more portion(s) of example method 3100 can be implemented on the hardware components of the device(s) described herein, for example, to train one or more systems or models. FIG. 31 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 31 is described with reference to elements/terms described with respect to other systems and figures for exemplary illustrated purposes and is not meant to be limiting. One or more portions of example method 3100 can be performed additionally, or alternatively, by other systems.

Example method 3100 can be a computer-implemented method for self-supervised training of an image processing model for histopathology images.

At 3102, example method 3100 includes obtaining a reference histopathology image. For example, an image (e.g., image 104) can be a histopathology image. Other image types may be used.

At 3104, example method 3100 includes generating an augmented histopathology image. In some implementations, generating the augmented histopathology image includes performing, for an input image, at least one of the following augmentations: at 3104a, applying a blur to the input image and injecting noise artifacts into the blurred input image; or, at 3104b, cropping a plurality of portions from the input image, wherein the plurality of portions are determined based on a minimum overlap criterion that has been updated over one or more iterations. In some implementations, the minimum overlap criterion is a hyperparameter learned during training of the image processing model. An example technique is a grid search over candidate minimum overlap criteria. Other search mechanisms may be used.

Applying a blur to the input image can include computing a Gaussian blur. The blur can be configured to simulate a defocused image capture optic.

Injecting noise artifacts into the blurred input image can include injecting compression artifacts configured to represent artifacts from an image compression algorithm. For instance, lossy compression (e.g., JPEG) noise artifacts can be introduced by encoding an image and then decoding the image using a compression algorithm. For instance, 3104a can include compressing the blurred image using an image compression algorithm.

At 3106, example method 3100 includes training an image processing model based on a similarity of latent representations generated by the image processing model respectively for the reference histopathology image and the augmented histopathology image. For instance, the training objective can be configured to cause the image processing model to learn to represent the attributes of interest in the image and disregard or mitigate the effects of noise information, such as blur, compression artifacts, etc.

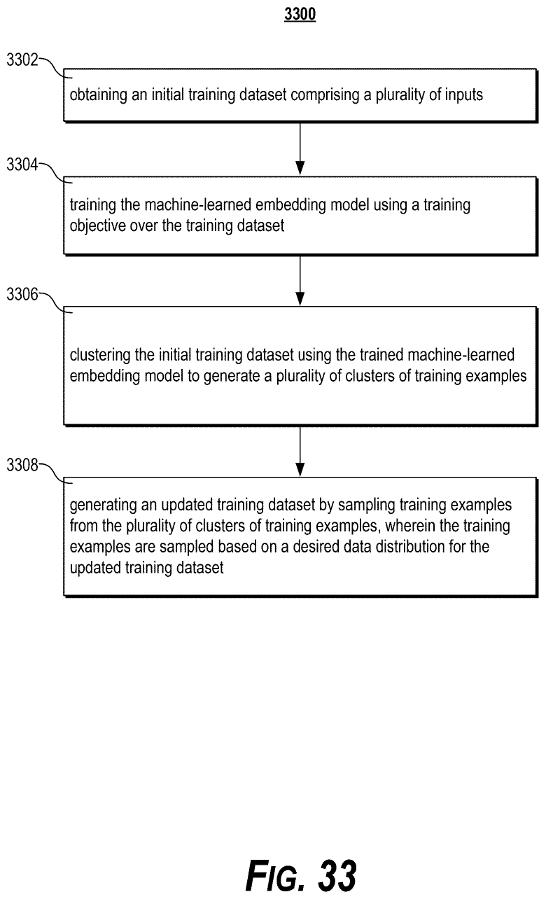

FIG. 32 depicts a flowchart of a method 3200 according to aspects of the present disclosure. For instance, an example machine-learned model can include an image processing model for processing histopathology images as described herein.

One or more portion(s) of example method 3200 can be implemented by a computing system that includes one or more computing devices such as, for example, computing systems described with reference to the other figures. Each respective portion of example method 3200 can be performed by any (or any combination) of one or more computing devices. Moreover, one or more portion(s) of example method 3200 can be implemented on the hardware components of the device(s) described herein, for example, to train one or more systems or models. FIG. 32 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 32 is described with reference to elements/terms described with respect to other systems and figures for exemplary illustrated purposes and is not meant to be limiting. One or more portions of example method 3200 can be performed additionally, or alternatively, by other systems.

At 3202, example method 3200 includes obtaining a reference histopathology image. For example, an image (e.g., image 104) can be a histopathology image. Other image types may be used.

At 3204, example method 3200 includes generating an augmented histopathology image. For instance, augmentation techniques as described above with respect to example method 3100 may be used.

At 3206, example method 3200 includes training the image processing model using a hybrid loss function computed based on a similarity of latent representations generated by the image processing model respectively for the reference histopathology image and the augmented histopathology image. In some implementations of example method 3200, the hybrid loss function includes a first loss component including a contrastive loss computed using at least one of the latent representations and a negative latent representation generated by the image processing model for a negative training example and a second loss component computed using similarities determined between the latent representations and a plurality of learnable prototypes.

Example method 3200 can include obtaining the reference histopathology image from a training batch. Example method 3200 can include computing the first loss component using the reference histopathology image and the augmented histopathology image as a positive pair for the contrastive loss and using the remainder of the batch as negative examples for the contrastive loss. For instance, a first loss component can be a SimCLR loss, and a second loss component can be an MSN loss. For instance, an objective of the second loss component can be to cause the model to match different latent representations of the same subject/image to the same learned prototype, or learned representation of information. By learning to match the representations to the same prototype the model can learn to identify similar subject matter (e.g., subject matter latently represented by the prototype).

For instance, each pair of teacher and student (e.g., anchor and target) global views in a non-contrastive loss can be treated, for a contrastive loss, as positive pairs in a batch with the rest of the batch's views (e.g., teacher and student global views) can be treated as negative examples.

In an example, the first component and the second component can be combined in a weighted combination. Example method 3200 can include weighting the relative contributions of the components of the hybrid loss using a loss hyperparameter. Example method 3200 can include learning a value for the loss hyperparameter during training of the image processing model.

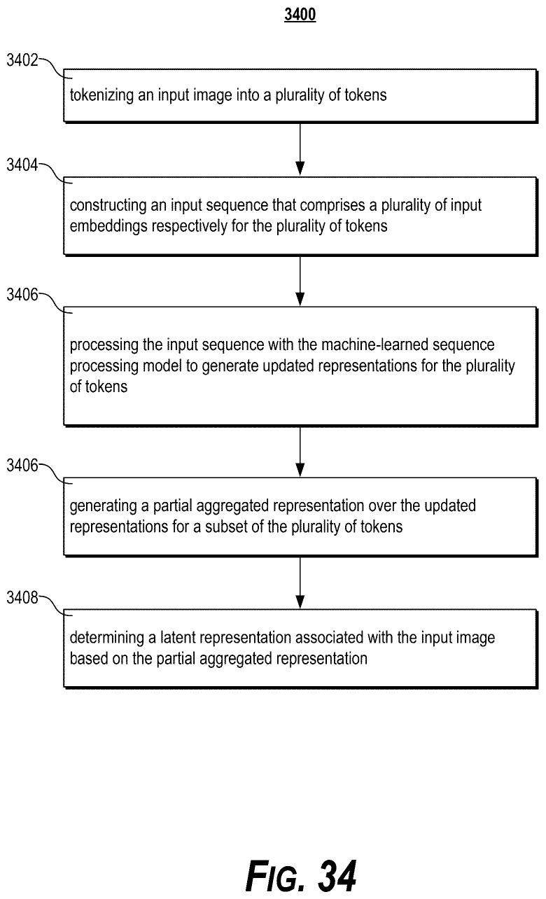

FIG. 33 depicts a flowchart of a method 3300 according to aspects of the present disclosure. For instance, an example machine-learned model can include an image processing model for processing histopathology images as described herein.

One or more portion(s) of example method 3300 can be implemented by a computing system that includes one or more computing devices such as, for example, computing systems described with reference to the other figures. Each respective portion of example method 3300 can be performed by any (or any combination) of one or more computing devices. Moreover, one or more portion(s) of example method 3300 can be implemented on the hardware components of the device(s) described herein, for example, to train one or more systems or models. FIG. 33 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 33 is described with reference to elements/terms described with respect to other systems and figures for exemplary illustrated purposes and is not meant to be limiting. One or more portions of example method 3300 can be performed additionally, or alternatively, by other systems.

At 3302, example method 3300 includes obtaining an initial training dataset including a plurality of inputs. The initial training dataset can be a dataset of training images or patches from images. The inputs can be images or image patches.

At 3304, example method 3300 includes training the machine-learned embedding model using a training objective over the training dataset. For example, the training objective can include a contrastive loss, non-contrastive loss, hybrid loss, or any other loss described herein.

At 3306, example method 3300 includes clustering the initial training dataset using the trained machine-learned embedding model to generate a plurality of clusters of training examples. For example, the trained machine-learned model can generate latent embeddings representing the training examples. A clustering algorithm (e.g., k-means) can be applied to generate clusters of training examples.

At 3308, example method 3300 includes generating an updated training dataset by sampling training examples from the plurality of clusters of training examples, wherein the training examples are sampled based on a desired data distribution for the updated training dataset. For instance, the sampling can be used to balance the original training dataset. For instance, a fixed or bounded number of patches can be sampled from each cluster. Different numbers of clusters and numbers of samples from each cluster can be used to adjust a representation coverage and training cost. For example, a number of clusters used to cluster the training data can be a learnable hyperparameter. The number of clusters can be learned over multiple training iterations.

Example method 3300 can include re-training the machine-learned embedding model or image processing model using a training objective over the updated training dataset. In some implementations, the self-supervised training objective used to re-train the machine-learned embedding model or image processing model over the updated training dataset is the same as the self-supervised training objective used to train the image processing model over the initial training dataset. In some implementations, re-training the machine-learned embedding model or image processing model includes training a new instance of the machine-learned embedding model or image processing model from an initialized state (e.g., with randomly initialized parameters, with parameters initialized based on prior pretraining, etc.). In some implementations, re-training the machine-learned embedding model or image processing model includes training the trained machine-learned embedding model or trained image processing model that was trained over the initial training dataset.

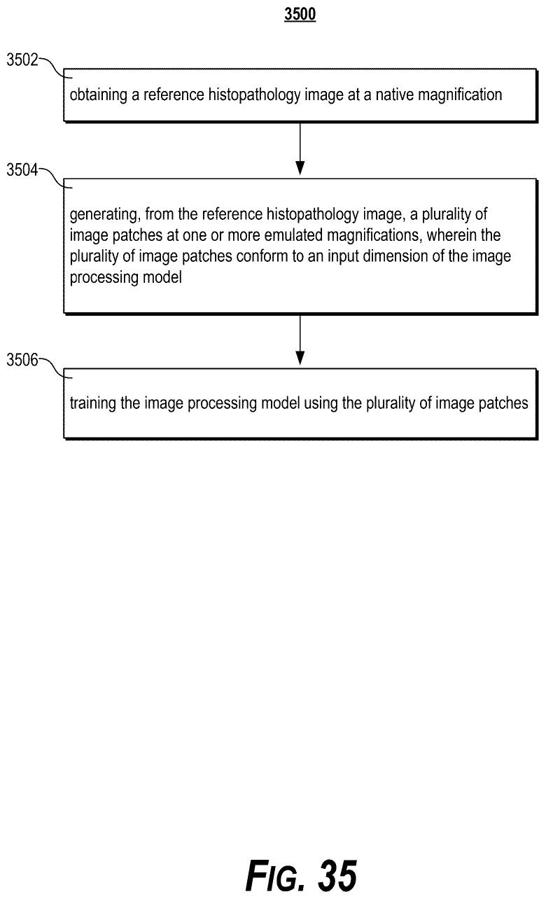

FIG. 34 depicts a flowchart of a method 3400 according to aspects of the present disclosure. For instance, an example machine-learned model can include an image processing model for processing histopathology images as described herein.

One or more portion(s) of example method 3400 can be implemented by a computing system that includes one or more computing devices such as, for example, computing systems described with reference to the other figures. Each respective portion of example method 3400 can be performed by any (or any combination) of one or more computing devices. Moreover, one or more portion(s) of example method 3400 can be implemented on the hardware components of the device(s) described herein, for example, to train one or more systems or models. FIG. 34 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 34 is described with reference to elements/terms described with respect to other systems and figures for exemplary illustrated purposes and is not meant to be limiting. One or more portions of example method 3400 can be performed additionally, or alternatively, by other systems.

At 3402, example method 3400 includes tokenizing an input image into a plurality of tokens. For example, as discussed above with respect to FIG. 6, an input image or image patch can be broken down into regions that are each embedded and represented as “tokens” in a sequence of data elements to be processed by a machine-learned sequence processing model.

At 3404, example method 3400 includes constructing an input sequence that includes a plurality of input embeddings respectively for the plurality of tokens. For example, a plurality of portions of an image or patch can be represented respectively with the plurality of tokens. The plurality of tokens can be composed into a sequence (e.g., as discussed with respect to FIG. 24).

At 3406, example method 3400 includes processing the input sequence with a machine-learned sequence processing model (e.g., machine-learned model 102, machine-learned model 1, machine-learned model 4, etc.) to generate updated representations for the plurality of tokens. For example, an attention layer can process a sequence and output a sequence containing updated representations that are updated to reflect the context within which the individual elements are positioned within the sequence.

At 3408, example method 3400 includes generating a partial aggregated representation over the updated representations for a subset of the plurality of tokens. For example, a representation can be aggregated over a subset of the sequence of tokens. For instance, a representation can be aggregated over a subset of tokens that correspond to a center of an input image (e.g., a portion of tokens corresponding to a center label). For example, the partial aggregated representation can be obtained using pooling operation at an output layer(s) of the machine-learned sequence processing model. In some implementations of example method 3400, the partial aggregated representation is obtained using a partial aggregation element in the input sequence that attends across the updated representations for a subset of the plurality of tokens. For example, an extra element in the sequence can be designated as a partial aggregation element that attends over a subset of the sequence (e.g., having an attention mask that limits attention to a particular area, or discounts attention signals from outside the area, etc.).

At 3410, example method 3400 includes determining a latent representation associated with the input image based on the partial aggregated representation. For example, the machine-learned sequence processing model can output an embedding based on the partial aggregated representation. For example, the partial aggregated representation (e.g., a pooling of center tokens) can be used concatenated with the standard class token embedding or used in isolation.

Example method 3400 can include generating a complete aggregated representation over the updated representations for the plurality of tokens. For example, a complete aggregated representation can be obtained using a partial aggregation element in the input sequence that attends across the updated representations for the plurality of tokens. In an example, the complete aggregated representation can be a cls token in a vision transformer (e.g., a token used to predict a class of an input image).

Example method 3400 can include determining the latent representation based on the partial aggregated representation and the complete aggregated representation. For instance, the partial aggregated representation and the complete aggregated representation can be concatenated.

In some implementations of example method 3400, the partial aggregated representation is concatenated with the complete aggregated representation.

In some implementations of example method 3400, the partial aggregated representations corresponds to an input location that, during training of the machine-learned image processing model, was associated with a label location.

FIG. 35 depicts a flowchart of a method 3500 according to aspects of the present disclosure. For instance, an example machine-learned model can include an image processing model for processing histopathology images as described herein.

One or more portion(s) of example method 3500 can be implemented by a computing system that includes one or more computing devices such as, for example, computing systems described with reference to the other figures. Each respective portion of example method 3500 can be performed by any (or any combination) of one or more computing devices. Moreover, one or more portion(s) of example method 3500 can be implemented on the hardware components of the device(s) described herein, for example, to train one or more systems or models. FIG. 35 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 35 is described with reference to elements/terms described with respect to other systems and figures for exemplary illustrated purposes and is not meant to be limiting. One or more portions of example method 3500 can be performed additionally, or alternatively, by other systems.

At 3502, example method 3500 includes obtaining a reference histopathology image at a reference magnification. For example, an image (e.g., image 104) can be a histopathology image. Other image types may be used. A reference magnification can be a magnification original to the data or otherwise providing a starting point or reference point for a magnification ratio.

At 3504, example method 3500 includes generating, from the reference histopathology image, a plurality of image patches at a respectively plurality of emulated magnifications, wherein the plurality of image patches conform to an input dimension of the image processing model. For instance, a slide image scanned at 20× magnification can be used to emulate one quarter of an image of the same slide scanned at 10× magnification. Accordingly, an image can provide a patch at native magnification by mapping pixels in the image to pixels in the patch at a unity ratio. The same image can provide a patch at a higher emulated magnification by mapping pixels in the image to pixels in the patch at a ratio less than unity (e.g., a patch of a given dimension can cover a smaller area of the original specimen to emulate a higher magnification). The same image can provide a patch at a lower emulated magnification by mapping pixels in the image to pixels in the patch at a ratio greater than unity (e.g., a patch of a given dimension can cover a larger area of the original specimen to emulate a lower magnification). Mapping at ratios greater than unity can be implemented by downsampling, subsampling, etc., including using machine-learned models to generate an output image at an output resolution based on an input image at a different input resolution. Mapping at ratios less than unity can be implemented by upsampling, oversampling, etc., including using machine-learned models to generate an output image at an output resolution based on an input image at a different input resolution. Various machine-learned models can include transformer-based models, convolutional neural networks, diffusion-based models, etc.

At 3506, example method 3500 includes training the image processing model using the plurality of image patches. For example, a training dataset can include a mixture of training examples of different magnifications. A training dataset can be constructed by sampling examples from each bin according to some prior distribution (e.g., with equal probabilities, with different probabilities, etc.). In this manner, for instance, training examples can reflect different native magnification levels.

In some implementations of example method 3500, the plurality of emulated magnifications are obtained by at least one of: generating an emulated higher magnification by processing a portion of the reference histopathology image, wherein the emulated higher magnification corresponds to a higher than native magnification; or generating an emulated lower magnification by processing a portion of the reference histopathology image, wherein the emulated lower magnification corresponds to a lower than native magnification.

In some implementations of example method 3500, the processing (e.g., to emulate the magnifications) is performed using at least one of: a machine-learned model; an upsampling algorithm; or a downsampling algorithm.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for self-supervised training of an image processing model for histopathology images, comprising:
obtaining a reference histopathology image;
generating an augmented histopathology image, wherein generating the augmented histopathology image comprises performing, for an input image, at least one of the following augmentations:
applying a blur to the input image and injecting noise artifacts into the blurred input image; or
cropping a plurality of portions from the input image, wherein the plurality of portions are determined based on a minimum overlap criterion that has been updated over one or more iterations; and
training the image processing model based on a similarity of latent representations generated by the image processing model respectively for the reference histopathology image and the augmented histopathology image.

2. The method of claim 1, comprising:
applying the blur, wherein the blur is configured to simulate a defocused image capture optic.

3. The method of claim 1, wherein the noise artifacts are configured to represent artifacts from an image compression algorithm.

4. The method of claim 1, wherein injecting noise artifacts into the blurred input image comprises:
compressing the blurred image using an image compression algorithm.

5. The method of claim 1, wherein the minimum overlap criterion is a hyperparameter learned during training of the image processing model.

6. A computer-implemented method for self-supervised training of an image processing model for histopathology images, comprising:
obtaining a reference histopathology image;
generating an augmented histopathology image; and
training the image processing model using a hybrid loss function computed based on a similarity of latent representations generated by the image processing model respectively for the reference histopathology image and the augmented histopathology image;
wherein the hybrid loss function comprises:
a first loss component comprising a contrastive loss computed using at least one of the latent representations and a negative latent representation generated by the image processing model for a negative training example; and
a second loss component computed using similarities determined between the latent representations and a plurality of learnable prototypes.

7. The method of claim 6, comprising:
weighting the relative contributions of the components of the hybrid loss using a loss hyperparameter;
wherein a value for the loss hyperparameter is learned during training of the image processing model.

8. The method of claim 6, comprising:
obtaining the reference histopathology image from a training batch; and
computing the first loss component using the reference histopathology image and the augmented histopathology image as a positive pair for the contrastive loss and using a remainder of the batch as negative examples for the contrastive loss.

9. A computer-implemented method for self-supervised training of a machine-learned embedding model, the method comprising:
obtaining an initial training dataset comprising a plurality of inputs;
training the machine-learned embedding model using a training objective over the training dataset;
clustering the initial training dataset using the trained machine-learned embedding model to generate a plurality of clusters of training examples; and
generating an updated training dataset by sampling training examples from the plurality of clusters of training examples, wherein the training examples are sampled based on a desired data distribution for the updated training dataset.

10. The method of claim 9, comprising:
re-training the machine-learned embedding model using a training objective over the updated training dataset.

11. The method of claim 10, wherein re-training the machine-learned embedding model comprises:
training a new instance of the machine-learned embedding model from an initialized state; or
further training the trained machine-learned embedding model that was trained over the initial training dataset.

12. The method of claim 9, wherein:
a number of clusters used to cluster the training data is a learnable hyperparameter; and
the number of clusters is learned over multiple training iterations.

13. The method of claim 10, wherein re-training the machine-learned embedding model comprises further training the trained machine-learned embedding model that was trained over the initial training dataset using a self-supervised training objective, wherein the self-supervised training objective is the same as the training objective used to train the machine-learned embedding model over the initial training dataset.

14. A computer-implemented method for processing images using a machine-learned sequence processing model, comprising:
tokenizing an input image into a plurality of tokens;
constructing an input sequence that comprises a plurality of input embeddings respectively for the plurality of tokens;
processing the input sequence with the machine-learned sequence processing model to generate updated representations for the plurality of tokens;
generating a partial aggregated representation over the updated representations for a subset of the plurality of tokens; and
determining a latent representation associated with the input image based on the partial aggregated representation.

15. The method of claim 14, comprising:
generating a complete aggregated representation over the updated representations for the plurality of tokens; and
determining the latent representation based on the partial aggregated representation and the complete aggregated representation.

16. The method of claim 15, wherein the partial aggregated representation is concatenated with the complete aggregated representation.

17. The method of claim 14, wherein the partial aggregated representations corresponds to an input location that, during training of the machine-learned image processing model, was associated with a label location.

18. The method of claim 14, wherein the partial aggregated representation is obtained using a partial aggregation element in the input sequence that attends across the updated representations for a subset of the plurality of tokens.

19. The method of claim 14, wherein the partial aggregated representation is obtained using pooling operation at an output layer of the machine-learned sequence processing model.

20. A computer-implemented method for self-supervised training of an image processing model for histopathology images, comprising:
obtaining a reference histopathology image at a native magnification;
generating, from the reference histopathology image, a plurality of image patches at a respectively plurality of emulated magnifications, wherein the plurality of image patches conform to an input dimension of the image processing model, wherein the plurality of emulated magnifications are obtained by at least one of:
generating an emulated higher magnification by processing a portion of the reference histopathology image using an upsampling algorithm, wherein the emulated higher magnification corresponds to a higher than native magnification; or
generating an emulated lower magnification by processing a portion of the reference histopathology image using a downsampling algorithm, wherein the emulated lower magnification corresponds to a lower than native magnification; and
training the image processing model using the plurality of image patches.
